(19) United States
(12) Patent Application Publication
(10) Pub. No.: US 2025/0206492 A1
(43) Pub. Date: Jun. 26, 2025

(54) LIQUID-TIGHT CONTAINER, METHODS FOR THE PRODUCTION THEREOF, AND USES

(71) Applicant: SIG Services AG, Neuhausen am Rheinfall (CH)

(72) Inventors: Valentin Buchty, Ettlingen (DE); Stefan Pelzer, Herzogenrath (DE); Michael Schaaf, Herzogenrath (DE)

(21) Appl. No.: 18/850,046

(22) PCT Filed: Mar. 20, 2023
(86) PCT No.: PCT/EP2023/057089

§ 371 Date: Sep. 23, 2024

(30) Foreign Application Priority Data
Mar. 21, 2022 (DE) 10 2022 202 764.7

(51) Int. Cl. B65D 3/12; B31B 50/66; B31B 105/00; B31B 110/20

(52) U.S. Cl. CPC B65D 3/12; B31B 50/66; B31B 2105/0022; B31B 2110/20

(57) ABSTRACT

The invention relates to a container comprising a container wall at least partially enclosing a container interior, and a first joining element; wherein a jacket element and a first end element each form a region of the container wall; wherein at least one first plane running parallel to the length of the container through the container interior comprises a first joining layer sequence, over the entire lateral extent of which, with respect to the first joining layer sequence, the jacket element, the first joining element and the first end element directly follow one another as layers; wherein the first joining element has a first surface contacting the first end element and a second surface contacting the jacket element; wherein an imaginary first straight line connects both end points of a first line formed in the at least one first plane by the first surface and lying within the first joining layer sequence; wherein an imaginary second straight line connects both end points of a second line formed in the at least one first plane by the second surface and lying within the first joining layer sequence; wherein the first straight line forms a first acute angle with the second straight line. The invention further relates to methods and a device for the production of the container and to uses of the container, of a sheet-like composite and of joining tools.

The present invention relates to a liquid-tight container comprising a container wall at least partially enclosing a container interior, and a first joining element; wherein a jacket element and a first end element each form a region of the container wall; wherein the jacket element
is at least partially formed from a first sheet-like material,
laterally delimits the container interior in relation to a length of the liquid-tight container, and
includes a first edge region with a first edge:
   wherein the first sheet-like material
comprises a first cardboard, and
has a bending stiffness in the range of 50 to 600 mN;
   wherein the first edge region is arranged at a first end of the liquid-tight container; wherein the first end element includes, preferably consists of, a central region and a further edge region which surrounds the central region, in particular laterally, and has a further edge; wherein the central region delimits the container interior, in relation to the length of the liquid-tight container, at the first end of the liquid-tight container in a first direction along the length of the liquid-tight container; wherein the further edge region is connected with a material bond to the jacket element by means of the first joining element; wherein the further edge forms a closed curve with a circumference; wherein the further edge region has an edge width extending from the further edge to the central region at each point of the closed curve; wherein the first edge region protrudes beyond the further edge region at each point of the closed curve in such a way that the first edge region has an overhang width from the further edge to the first edge; wherein the overhang width is measured on a side of the first edge region which faces away from the first end element; wherein the overhang width along at least 50% of the circumference is at least 30% of the edge width; wherein at least one first plane running parallel to the length of the liquid-tight container through the container interior comprises a first joining layer sequence, over the entire lateral extent of which, relative to the first joining layer sequence, the jacket element, the first joining element and the first end element follow one another directly as layers; wherein the first joining element has a first surface contacting the first end element and a second surface contacting the jacket element; wherein an imaginary first straight line connects both end points of a first line formed in the at least one first plane by the first surface and lying within the first joining layer sequence; wherein an imaginary second straight line connects both end points of a second line formed in the at least one first plane by the second surface and lying within the first joining layer sequence; wherein the first straight line forms a first acute angle with the second straight line. The invention further relates to methods and a device for the production of the container and to uses of the container, of a sheet-like composite and of joining tools.

For a long time, foodstuff has been preserved, whether it is foodstuff for human consumption or an animal feed product, by storing it either in a can or in a glass jar with a lid. Cans and jars have a number of disadvantages. For example, cans and jars have a considerable empty weight, which leads to increased energy expenditure during transport. In addition, the production of glass, tinplate or aluminum requires a relatively high amount of energy, even if the raw materials used come from recycling. In the case of jars, the additional expense of transport is a complicating factor. The jars are usually prefabricated in a glassworks and then have to be transported to the plant that fills the food, using considerable transport volumes. In addition, jars and cans can only be opened with considerable force or with the help of tools, making them rather cumbersome to open. In the case of cans, there is also a high risk of injury from sharp edges that arise when opening them. When it comes to jars, it happens again and again that when filling or opening the filled jars, glass splinters get into the foodstuff, which in the worst case can lead to internal injuries when the foodstuff is consumed. In addition, both cans and jars must be labeled to identify and advertize the foodstuff contents. The jars and cans cannot easily be printed directly with information and advertising images. In addition to the actual print, a substrate, a paper or a suitable film, as well as a fastening agent, an adhesive or a sealing agent, are necessary.

Other packaging systems are known from the prior art for storing foodstuff over a long period of time with as little impairment as possible. These are containers made from sheet-like composites-often also referred to as laminates. Such sheet-like composites are often made up of a thermoplastic layer, a carrier layer, usually made of cardboard or paper, which gives the container dimensional stability, an adhesion promoter layer, a barrier layer and another plastics layer. Since the carrier layer gives the container made from the laminate dimensional stability, these containers, in contrast to film bags, can be seen as a further development of the aforementioned jars and cans.

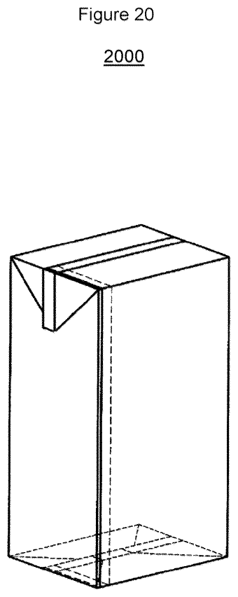

One-piece, dimensionally stable foodstuff containers made of laminate are often substantially cuboid-shaped (cf. FIG. 20). These containers are made by folding and sealing a continuous piece of laminate. The shaping of the container bottom and the container head often requires particularly sharp and numerous folds, which also sometimes cross one another. Such accumulations of folds always tend to be detrimental to a particularly long shelf life of the foodstuff in the container. On the one hand, the barrier layer can be damaged at sharp fold edges or fold intersections. This is especially true in the case of a metal foil as a barrier layer. If the barrier layer is damaged, the gas-tightness of the container suffers. Oxygen entering the container reduces its shelf life. On the other hand, the carrier layer is foldable, but also stiff enough to give the container dimensional stability. This often means that it is not possible to cleanly create as many sharp folds as desired in a small area. Especially in the case of the container bottom, many folded plies of the laminate often lie on top of one another. Since the accumulated folds cannot be formed perfectly sharply and cleanly and, in addition, a targeted local application of the required amount of sealing agent is often not possible, it is often the case that the laminate plies are not sealed together completely. This may thus lead to the formation of cavities between the plies. Germs can settle in such cavities and are difficult to eliminate even by increased disinfection measures during container production. In addition, such cavities can form channels through the layer sequence of the laminate, which enable the transport of gas and liquid through the layer sequence and can thus significantly impair the tightness of the container.

These shelf life problems of one-piece containers can be addressed by reducing the number of folds. For this purpose, the container can be constructed in several parts, i.e. with a separate lid and/or bottom. The lid or bottom is then made from a separate piece of laminate, which is joined to a piece of laminate that forms the side wall of the container during container production. Such multi-part containers have significantly less sharp folds than single-part laminate containers. As a result, fewer leakage problems occur in the unloaded container and a longer shelf life can be achieved more reliably.

However, the tightness of these multi-part containers depends to a large extent on the connecting seam between the lid/bottom and side wall of the container. As a result, such multi-part containers are more susceptible to losses of tightness due to mechanical influences, such as those that occur when a container falls or when filled containers are stacked.

In general, it is an object of the present invention to at least partially overcome a disadvantage of the prior art.

A further object of the invention is to provide a dimensionally stable, liquid-tight foodstuff container made of laminate, which is characterized by an improved shelf life, in particular after a mechanical impact such as a fall. Furthermore, it is an object of the invention to provide a dimensionally stable, liquid-tight foodstuff container made of laminate, which has a tighter container bottom or a tighter container head or both, in particular after a mechanical impact such as a fall. A further object of the invention is to provide a dimensionally stable, liquid-tight foodstuff container made of laminate, which is characterized by improved mechanical stability, in particular against a fall. A further object of the invention is to provide a method which is particularly designed for producing and preferably also filling one of the above-mentioned advantageous foodstuff containers.

The independent claims make a contribution to achieving, at least partially, at least one, and preferably several, of the above objects. The dependent claims provide preferred embodiments that contribute to at least partially achieving at least one of the objects.

A contribution to achieving at least one of the objects of the invention is made by an embodiment 1 of a liquid-tight container comprising a container wall at least partially, preferably completely, enclosing a container interior, and a first joining element; wherein a jacket element and a first end element each form a region of the container wall; wherein the jacket element
is at least partially formed, preferably completely formed, from a first sheet-like material,
in relation to a length of the liquid-tight container laterally delimits the container interior, and
includes a first edge region with a first edge;
   wherein the first sheet-like material
comprises a first cardboard, and
has a bending stiffness in a range from 50 to 600 mN, preferably from 50 to 500 mN, more preferably from 55 to 480 mN, more preferably from 60 to 460 mN, even more preferably from 65 to 440 mN, most preferably from 70 to 420 mN;
   wherein the first edge region is arranged at a first end of the liquid-tight container; wherein the first end element includes a central region and a further edge region which surrounds the central region and has a further edge; wherein the central region delimits the container interior, in relation to the length of the liquid-tight container, at the first end of the liquid-tight container in a first direction along the length of the liquid-tight container; wherein the further edge region is connected with a material bond to the jacket element by means of the first joining element; wherein the further edge forms a closed curve with a circumference; wherein the further edge region has an edge width extending from the further edge to the central region at each point of the closed curve; wherein the first edge region protrudes beyond the further edge region at each point of the closed curve in such a way that the first edge region has an overhang width from the further edge to the first edge; wherein the overhang width is measured on a side of the first edge region which faces away from the first end element; wherein the overhang width along at least 50%, preferably at least 60%, more preferably at least 70%, more preferably at least 80%, more preferably at least 90%, even more preferably at least 95%, most preferably 100%, of the circumference is at least 30%, preferably at least 40%, more preferably at least 50%, more preferably at least 60%, even more preferably 70%, of the edge width; wherein at least one, preferably each, first plane running parallel to the length of the liquid-tight container through the container interior comprises a first joining layer sequence, over the entire lateral extent of which, relative to the first joining layer sequence, the jacket element, the first joining element and the first end element follow one another directly as layers; wherein the first joining element has a first surface contacting the first end element and a second surface contacting the jacket element; wherein an imaginary first straight line connects both end points of a first line formed in the at least one first plane by the first surface and lying within the first joining layer sequence; wherein an imaginary second straight line connects both end points of a second line formed in the at least one first plane by the second surface and lying within the first joining layer sequence; wherein the first straight line forms a first acute angle with the second straight line.

Preferably, the overhang width along at least 50%, preferably at least 60%, more preferably at least 70%, more preferably at least 80%, more preferably at least 90%, even more preferably at least 95%, most preferably 100%, of the circumference is 30 to 100%, preferably 40 to 100%, more preferably 50 to 100%, even more preferably 60 to 100%, most preferably 70 to 100%, of the edge width. Preferably, but not necessarily, the first edge region is in contact with the further edge region, preferably along at least 50%, preferably at least 60%, more preferably at least 70%, more preferably at least 80%, more preferably at least 90%, even more preferably at least 95%, most preferably 100%, of the overhang width. For this purpose, the first edge region is preferably folded around the further edge in such a way that the first edge points towards the central region. More preferably, the first edge region is connected to the further edge region, preferably along at least 50%, preferably at least 60%, more preferably at least 70%, more preferably at least 80%, more preferably at least 90%, even more preferably at least 95%, most preferably 100%, of the overhang width. Here, the folded region of the first edge region is preferably connected to the further edge region, preferably sealed or welded. This ensures that neither the first edge nor the further edge points in the first direction and is therefore exposed to the potentially damp environment. In this context, a person skilled in the art will speak of flanging.

A preferred first cardboard has a basis weight in a range from 50 to 500 g/m², preferably from 100 to 500 g/m², more preferably from 100 to 450 g/m², more preferably from 150 to 450 g/m², even more preferably from 170 to 420 g/m², most preferably from 190 to 400 g/m².

In an embodiment 2 according to the invention, the liquid-tight container is designed according to its embodiment 1, wherein in the at least one first plane at least 70%, preferably at least 80%, more preferably at least 90%, even more preferably at least 95%, particularly preferably at least 98%, most preferably 100%, of a surface area of the first joining element lies between the first straight line and the second straight line. Preferably, the first joining element in the at least one first plane has the shape of a triangle or a quadrilateral. A preferred quadrilateral in this case is a trapezoid. A preferred trapezoid is not a parallelogram. Alternatively or additionally preferably, the first joining element in the at least one first plane has the shape of a cross section of a wedge, wherein a pointed end of the wedge has the first acute angle. The shape of the wedge can be triangular here. However, the end of the wedge that tapers to the first acute angle may also be missing.

In an embodiment 3 according to the invention, the liquid-tight container is designed according to its embodiment 1 or 2, wherein for at least 10%, preferably at least 20%, more preferably at least 30%, more preferably at least 40%, more preferably at least 50%, more preferably at least 60%, more preferably at least 70%, more preferably at least 80%, even more preferably at least 90%, most preferably at least 95%, of an outer circumference of the jacket element there is at least one first plane running parallel to the length of the liquid-tight container through the container interior and the outer circumference of the jacket element, which first plane comprises the first joining layer sequence, so that an imaginary first straight line connects both end points of a first line formed in the at least one first plane by the first surface and lying within the first joining layer sequence, and an imaginary second straight line connects both end points of a second line formed in the at least one first plane by the second surface and lying within the first joining layer sequence, wherein the first straight line forms a first acute angle with the second straight line. In other words, there is preferably for at least 10%, preferably at least 20%, more preferably at least 30%, more preferably at least 40%, more preferably at least 50%, more preferably at least 60%, more preferably at least 70%, more preferably at least 80%, even more preferably at least 90%, most preferably at least 95%, of an outer circumference of the jacket element at least one first plane running parallel to the length of the liquid-tight container through the container interior and the outer circumference of the jacket element, in which first plane the first straight line defined in embodiment 1 of the liquid-tight container forms the first acute angle with the second straight line.

In an embodiment 4 according to the invention, the liquid-tight container is designed according to one of its preceding embodiments, wherein the first acute angle is in a range from 0.5 to 10.0°, preferably from 1.0 to 9.0°, more preferably from 1.5 to 8.0°, more preferably from 2.0 to 7.5°, more preferably from 2.5 to 7.0°, more preferably from 3.0 to 6.5°, more preferably from 3.2 to 6.4°, more preferably from 3.5 to 6.4°, more preferably from 4.0 to 6.4°, even more preferably from 4.5 to 6.4°, most preferably from 5.0 to 6.4°.

In an embodiment 5 according to the invention, the liquid-tight container is designed according to one of its preceding embodiments, wherein a vertex of the first acute angle is arranged in the first direction after the legs of the first acute angle. The first acute angle here forms an arrowhead that points away from the container interior.

In an embodiment 6 according to the invention, the liquid-tight container is designed according to one of its preceding embodiments, wherein the first straight line forms an angle in a range from 1.3 to 13.5°, preferably from 2.0 to 13.0°, more preferably from 3.0 to 12.0°, more preferably from 4.0 to 11.0°, even more preferably from 5.0 to 10.0°, most preferably from 5.8 to 9.9°, with the first direction. Alternatively or additionally, the second straight line preferably forms an angle in a range from 0.4 to 5.0°, preferably from 0.5 to 4.5°, more preferably from 0.6 to 4.0°, even more preferably from 0.7 to 3.7°, most preferably from 0.8 to 3.5°, with the first direction. Alternatively or additionally, a region of the first end element which contacts the first surface is preferably angled laterally inwardly or outwardly, which is more preferred, based on the liquid-tight container, in each case preferably at an angle in a range of from 1.3 to 13.5°, preferably from 2.0 to 13.0°, more preferably from 3.0 to 12.0°, more preferably from 4.0 to 11.0°, even more preferably from 5.0 to 10.0°, most preferably from 5.8 to 9.9°, relative to the first direction. Alternatively or additionally, a region of the jacket element which contacts the second surface is preferably angled laterally inwardly or outwardly, which is more preferred, based on the liquid-tight container, preferably at an angle in a range of 0.4 to 5.0°, preferably 0.5 to 4.5°, more preferably 0.6 to 4.0°, even more preferably 0.7 to 3.7°, most preferably 0.8 to 3.5°, relative to the first direction.

In an embodiment 7 according to the invention, the liquid-tight container is designed according to one of its preceding embodiments, wherein the jacket element at least partially, preferably laterally completely, surrounds the first end element.

In an embodiment 8 according to the invention, the liquid-tight container is designed according to one of its preceding embodiments, wherein the first cardboard has a basis weight in a range from 50 to 500 g/m², preferably from 100 to 500 g/m², more preferably from 100 to 450 g/m², more preferably from 150 to 450 g/m², even more preferably from 170 to 420 g/m², most preferably from 190 to 400 g/m².

In an embodiment 9 according to the invention, the liquid-tight container is designed according to one of its preceding embodiments, wherein the first sheet-like material has a first material direction and a further material direction, wherein the first material direction is perpendicular to the further material direction and to a thickness of the first sheet-like material at every point on a surface of the first sheet-like material, wherein the first sheet-like material satisfies one or more, preferably each, of the following criteria:
A] the first sheet-like material has an extensibility in the first material direction in the range of 2.5 to 10%, preferably 3.5 to 9%, more preferably 4.5 to 8%;
B] the first sheet-like material has an extensibility in the further material direction in the range of 1 to 6%, preferably 1.5 to 5.5%, more preferably 2 to 4.5%;
C] the first sheet-like material has a modulus of elasticity in the first material direction in the range of 800 to 4000 MPa, preferably 1000 to 3500 MPa, more preferably 1250 to 2500 MPa;
D] the first sheet-like material has a modulus of elasticity in the further material direction in the range of 1500 to 6000 MPa, preferably 2000 to 5000 MPa, more preferably 2500 to 4500 MPa.

Preferably, the first material direction in the liquid-tight container according to the invention runs along the first direction. In a further preferred embodiment, the further material direction in the liquid-tight container according to the invention runs along the first direction.

In an embodiment 10 according to the invention, the liquid-tight container is designed according to one of its preceding embodiments, wherein the first sheet-like material has a first material direction and a further material direction, wherein the first material direction is perpendicular to the further material direction and to a thickness of the first sheet-like material at every point on a surface of the first sheet-like material, wherein an extensibility of the first sheet-like material in the first material direction is greater than an extensibility of the first sheet-like material in the further material direction. Alternatively or additionally, a modulus of elasticity of the first sheet-like material in the first material direction is smaller than a modulus of elasticity of the first sheet-like material in the further material direction.

In an embodiment 11 according to the invention, the liquid-tight container is designed according to one of its preceding embodiments, wherein the first sheet-like material is a first sheet-like composite comprising a first layer sequence; wherein the first layer sequence comprises, preferably over its entire surface, a first carrier layer.

In an embodiment 12 according to the invention, the liquid-tight container is designed according to its embodiment 11, wherein the first carrier layer comprises the first cardboard, preferably consists thereof.

In an embodiment 13 according to the invention, the liquid-tight container is designed according to its embodiment 11 or 12, wherein the first carrier layer in the first layer sequence is overlaid with a first polymer inner layer on a side facing the container interior, preferably over its entire surface.

In an embodiment 14 according to the invention, the liquid-tight container is designed according to its embodiment 13, wherein the first joining element is at least partially formed from the first polymer inner layer. Alternatively or additionally preferably, the further joining element is formed at least partially from the first polymer inner layer. For this purpose, it is possible that the first polymer inner layer was softened or melted in certain areas and the first joining element can have been formed from the softened or melted area. In this case, a transition between the first polymer inner layer and the first joining element is preferably continuous. Furthermore, the first joining element preferably also comprises the materials of which the first polymer inner layer consists.

In an embodiment 15 according to the invention, the liquid-tight container is designed according to one of its embodiments 11 to 14, wherein the first carrier layer in the first layer sequence is overlaid with a first polymer outer layer on a side facing away from the container interior, preferably over its entire surface.

In an embodiment 16 according to the invention, the liquid-tight container is designed according to one of its embodiments 13 to 15, wherein the first layer sequence between the first carrier layer and the first polymer inner layer, preferably over its entire surface, includes a first barrier layer.

In an embodiment 17 according to the invention, the liquid-tight container is designed according to one of its embodiments 13 to 16, wherein the first carrier layer has at least one through-hole which is covered at least by the first polymer inner layer. Alternatively or in addition to the first polymer inner layer, the at least one through-hole in the first carrier layer is covered with the first barrier layer.

In an embodiment 18 according to the invention, the liquid-tight container is designed according to one of its preceding embodiments, wherein the first end element is formed at least partially, preferably completely, from a second sheet-like material. The second sheet-like material may differ in its structure from the first sheet-like material. Preferably, the second sheet-like material has the same structure as the first sheet-like material.

In an embodiment 19 according to the invention, the liquid-tight container is designed according to its embodiment 18, wherein the second sheet-like material comprises, preferably consists of, one selected from the group consisting of cardboard, paperboard, and paper, or a combination of at least two thereof, preferably over its entire surface. Preferably, the second sheet-like material comprises a second cardboard. Preferably, the second cardboard has one or more of the properties described above for the first cardboard.

In an embodiment 20 according to the invention, the liquid-tight container is designed according to its embodiment 18 or 19, wherein the second sheet-like material is a second sheet-like composite comprising a second layer sequence; wherein the second layer sequence comprises a second carrier layer, preferably over its entire surface. A structure of the second carrier layer may differ from a structure of the first carrier layer. Preferably, the second carrier layer has the same structure as the first carrier layer.

In an embodiment 21 according to the invention, the liquid-tight container is designed according to its embodiment 20, wherein the second carrier layer comprises, preferably consists of, one selected from the group consisting of cardboard, paperboard, and paper, or a combination of at least two thereof. Preferably, the second carrier layer comprises a second cardboard. Furthermore, the second carrier layer preferably consists of the second cardboard. Preferably, the second cardboard has one or more of the properties described above for the first cardboard.

In an embodiment 22 according to the invention, the liquid-tight container is designed according to its embodiment 20 or 21, wherein the second carrier layer in the second layer sequence is overlaid with a second polymer inner layer on a side facing the container interior, preferably over its entire surface. The second polymer inner layer may differ from the first polymer inner layer, for example in its material or its basis weight. Preferably, the second polymer inner layer has the same structure as the first polymer inner layer, i.e., in particular made of the same material and having the same basis weight.

In an embodiment 23 according to the invention, the liquid-tight container is designed according to its embodiment 22, wherein the first joining element is formed at least partially from the second polymer inner layer. For this purpose, it is possible that the second polymer inner layer was softened or melted in certain areas and the first joining element can have been formed from the softened or melted area. In this case, a transition between the second polymer inner layer and the first joining element is preferably continuous. Furthermore, the first joining element preferably also comprises the materials of which the second polymer inner layer consists. Furthermore, the first joining element is preferably formed from the first polymer inner layer and the second polymer inner layer.

In an embodiment 24 according to the invention, the liquid-tight container is designed according to one of its embodiments 20 to 23, wherein the second carrier layer in the second layer sequence is overlaid with a second polymer outer layer on a side facing away from the container interior, preferably over its entire surface. The second polymer outer layer may differ from the first polymer outer layer, for example in its material or its basis weight. Preferably, the second polymer outer layer has the same structure as the first polymer outer layer, i.e., in particular made of the same material and having the same basis weight.

In an embodiment 25 according to the invention, the liquid-tight container is designed according to one of its embodiments 22 to 24, wherein the second layer sequence between the second carrier layer and the second polymer inner layer, preferably over their entire surfaces, includes a second barrier layer. The second barrier layer may differ from the first barrier layer, for example in its material or its basis weight. Preferably, the second barrier layer has the same structure as the first barrier layer, i.e., in particular made of the same material and having the same basis weight.

In an embodiment 26 according to the invention, the liquid-tight container is designed according to one of its embodiments 22 to 25, wherein the second carrier layer has at least one through-hole which is covered at least by the second polymer inner layer. Alternatively or in addition to the second polymer inner layer, the at least one through-hole in the second carrier layer is covered with the second barrier layer. Preferably, the first end element closes the liquid-tight container at a first end, the first end preferably being a container head which is opposite to a container bottom along the length of the liquid-tight container.

In an embodiment 27 according to the invention, the liquid-tight container is designed according to one of its preceding embodiments, wherein, with respect to the container interior, the first end element is curved concavely, i.e., towards the container interior, or convexly, i.e., away from the container interior.

In an embodiment 28 according to the invention, the liquid-tight container is designed according to one of its preceding embodiments, wherein the first end element, relative to the length of the liquid-tight container, is arranged at the first end of the liquid-tight container; wherein the jacket element delimits the container interior additionally in a further direction opposite to the first direction. Preferably, the first end element closes the liquid-tight container at the first end. Alternatively or additionally, the jacket element preferably closes the liquid-tight container at a further end, opposite the first end relative to the length of the liquid-tight container.

In an embodiment 29 according to the invention, the liquid-tight container is designed according to one of its embodiments 1 to 27, wherein the first end element, relative to the length of the liquid-tight container, is arranged at a first end of the liquid-tight container; wherein a further end element forms a further region of the container wall; wherein the further end element delimits the container interior in a further direction opposite to the first direction; wherein the further end element, relative to the length of the liquid-tight container, is arranged at a further end of the liquid-tight container opposite the first end; wherein the further end element is connected to the jacket element.

In an embodiment 30 according to the invention, the liquid-tight container is designed according to its embodiment 29, wherein the liquid-tight container additionally comprises a further joining element; wherein the further end element is connected with a material bond to the jacket element by means of the further joining element; wherein at least one, preferably each, further plane running parallel to the length of the liquid-tight container through the container interior comprises a further joining layer sequence, over the entire lateral extent of which, relative to the further joining layer sequence, the jacket element, the further joining element and the further end element follow one another directly as layers; wherein the further joining element has a third surface contacting the further end element and a fourth surface contacting the jacket element: wherein an imaginary third straight line connects both end points of a third line formed in the at least one further plane by the third surface and lying within the further joining layer sequence; wherein an imaginary fourth straight line connects both end points of a fourth line formed in the at least one further plane by the fourth surface and lying within the further joining layer sequence; wherein the third straight line forms a further acute angle with the fourth straight line.

In an embodiment 31 according to the invention, the liquid-tight container is designed according to its embodiment 30, wherein in the at least one further plane at least 70%, preferably at least 80%, more preferably at least 90%, even more preferably at least 95%, particularly preferably at least 98%, most preferably 100%, of a surface area of the further joining element lies between the third straight line and the fourth straight line. Preferably, the further joining element in the at least one further plane has the shape of a triangle or a quadrilateral. A preferred quadrilateral in this case is a trapezoid. A preferred trapezoid is not a parallelogram. Alternatively or additionally preferably, the further joining element in the at least one further plane has the shape of a cross section of a wedge, wherein a pointed end of the wedge has the first acute angle. The shape of the wedge can be triangular here. However, the end of the wedge that tapers to the first acute angle may also be missing.

In an embodiment 32 according to the invention, the liquid-tight container is designed according to its embodiment 30 or 31, wherein for at least 10%, preferably at least 20%, more preferably at least 30%, more preferably at least 40%, more preferably at least 50%, more preferably at least 60%, more preferably at least 70%, more preferably at least 80%, even more preferably at least 90%, most preferably at least 95%, of an outer circumference of the jacket element there is at least one further plane running parallel to the length of the liquid-tight container through the container interior and the outer circumference of the jacket element, which further plane comprises the further joining layer sequence, so that an imaginary third straight line connects both end points of a third line formed in the at least one plane by the third surface and lying within the further joining layer sequence, and an imaginary fourth straight line connects both end points of a fourth line formed in the at least one plane by the fourth surface and lying within the further joining layer sequence, wherein the third straight line forms a further acute angle with the fourth straight line. In other words, there is preferably for at least 10%, preferably at least 20%, more preferably at least 30%, more preferably at least 40%, more preferably at least 50%, more preferably at least 60%, more preferably at least 70%, more preferably at least 80%, even more preferably at least 90%, most preferably at least 95%, of an outer circumference of the jacket element at least one further plane running parallel to the length of the liquid-tight container through the container interior and the outer circumference of the jacket element, in which further plane the third straight line defined in embodiment 32 of the liquid-tight container forms the further acute angle with the fourth straight line.

In an embodiment 33 according to the invention, the liquid-tight container is designed according to one of its embodiments 29 to 32, wherein the first end element closes the liquid-tight container at the first end: wherein the further end element closes the liquid-tight container at the further end.

In an embodiment 34 according to the invention, the liquid-tight container is designed according to one of its embodiments 28 to 33, wherein
A) the first end is a container bottom and the further end is a container head: or
B) the first end is a container head and the further end is a container bottom.

In an embodiment 35 according to the invention, the liquid-tight container is designed according to one of its embodiments 30 to 34, wherein the further acute angle is in a range from 0.5 to 10.0°, preferably from 1.0 to 9.0°, more preferably from 1.5 to 8.0°, more preferably from 2.0 to 7.5°, more preferably from 2.5 to 7.0°, more preferably from 3.0 to 6.5°, more preferably from 3.2 to 6.4°, more preferably from 3.5 to 6.4°, more preferably from 4.0 to 6.4°, even more preferably from 4.5 to 6.4°, most preferably from 5.0 to 6.4°.

In an embodiment 36 according to the invention, the liquid-tight container is designed according to one of its embodiments 30 to 35, wherein a vertex of the further acute angle is arranged in the further direction after the legs of the further acute angle. The further acute angle here forms an arrowhead that points away from the container interior.

In an embodiment 37 according to the invention, the liquid-tight container is designed according to one of its embodiments 30 to 36, wherein the third straight line forms an angle in a range from 1.3 to 13.5°, preferably from 2.0 to 13.0°, more preferably from 3.0 to 12.0°, more preferably from 4.0 to 11.0°, even more preferably from 5.0 to 10.0°, most preferably from 5.8 to 9.9°, with the first direction. Alternatively or additionally, the fourth straight line preferably forms an angle in a range from 0.4 to 5.0°, preferably from 0.5 to 4.5°, more preferably from 0.6 to 4.0°, even more preferably from 0.7 to 3.7°, most preferably from 0.8 to 3.5°, with the first direction. Alternatively or additionally, a region of the further end element which contacts the third surface is preferably angled laterally inwardly or outwardly, which is more preferred, based on the liquid-tight container, in each case preferably at an angle in a range of from 1.3 to 13.5°, preferably from 2.0 to 13.0°, more preferably from 3.0 to 12.0°, more preferably from 4.0 to 11.0°, even more preferably from 5.0 to 10.0°, most preferably from 5.8 to 9.9°, relative to the first direction. Alternatively or additionally, a region of the jacket element which contacts the fourth surface is preferably angled laterally inwardly or outwardly, which is more preferred, based on the liquid-tight container, preferably at an angle in a range of 0.4 to 5.0°, preferably 0.5 to 4.5°, more preferably 0.6 to 4.0°, even more preferably 0.7 to 3.7°, most preferably 0.8 to 3.5°, relative to the first direction.

In an embodiment 38 according to the invention, the liquid-tight container is designed according to one of its embodiments 29 to 37, wherein the jacket element at least partially surrounds the further end element, preferably laterally completely.

In an embodiment 39 according to the invention, the liquid-tight container is designed according to one of its embodiments 29 to 38, wherein the further end element is formed at least partially, preferably completely, from a third sheet-like material. The third sheet-like material may differ in its structure from the first sheet-like material or the second sheet-like material or from both. Preferably, the second sheet-like material has the same structure as the first sheet-like material or the second sheet-like material or both. Alternatively, the further end element is preferably formed at least partially, preferably completely, from a molded body. A preferred molded body is made of plastic. Preferably, the molded body includes a pouring hole.

In an embodiment 40 according to the invention, the liquid-tight container is designed according to its embodiment 39, wherein the third sheet-like material includes, preferably consists of, one selected from the group consisting of cardboard, paperboard, and paper, or a combination of at least two thereof, preferably over its entire surface. Preferably, the third sheet-like material comprises a third cardboard. Preferably, the third cardboard has one or more of the properties described above for the first cardboard.

In an embodiment 41 according to the invention, the liquid-tight container is designed according to its embodiment 39 or 40, wherein the third sheet-like material is a third sheet-like composite comprising a third layer sequence: wherein the third layer sequence includes a third carrier layer. A structure of the third carrier layer may differ from a structure of the first carrier layer or the second carrier layer or both. Preferably, the third carrier layer has the same structure as the first carrier layer or the second carrier layer or both.

In an embodiment 42 according to the invention, the liquid-tight container is designed according to its embodiment 41, wherein the third carrier layer comprises, preferably consists of, one selected from the group consisting of cardboard, paperboard, and paper, or a combination of at least two thereof. Preferably, the third carrier layer comprises a third cardboard. Furthermore, the second carrier layer preferably consists of the third cardboard. Preferably, the third cardboard has one or more of the properties described above for the first cardboard.

In an embodiment 43 according to the invention, the liquid-tight container is designed according to its embodiment 41 or 42, wherein the third carrier layer in the third layer sequence is overlaid with a third polymer inner layer on a side facing the container interior, preferably over its entire surface. The third polymer inner layer may differ from the first polymer inner layer or the second polymer inner layer or from both, for example in its material or its basis weight. Preferably, the third polymer inner layer has the same structure as the first polymer inner layer or the second polymer inner layer or both, i.e. in particular made of the same material and having the same basis weight.

In an embodiment 44 according to the invention, the liquid-tight container is designed according to its embodiment 43, wherein the further joining element is at least partially formed from the third polymer inner layer. Alternatively or additionally preferably, the further joining element is formed at least partially from the first polymer inner layer. For this purpose, it is possible that the first or third polymer inner layer or both was softened or melted in certain areas and the further joining element can have been formed from the softened or melted area. In this case, a transition between the first and/or third polymer inner layer and the first joining element is preferably continuous. Furthermore, the first joining element preferably also comprises the materials of which the first and/or third polymer inner layer consists.

In an embodiment 45 according to the invention, the liquid-tight container is designed according to one of its embodiments 41 to 44, wherein the third carrier layer in the third layer sequence is overlaid with a third polymer outer layer on a side facing away from the container interior, preferably over its entire surface. The third polymer outer layer may differ from the first polymer outer layer or the second polymer outer layer or from both, for example in its material or its basis weight. Preferably, the third polymer outer layer has the same structure as the first polymer outer layer or the second polymer outer layer or both, i.e., in particular made of the same material and having the same basis weight.

In an embodiment 46 according to the invention, the liquid-tight container is designed according to one of its embodiments 43 to 45, wherein the third layer sequence between the third carrier layer and the third polymer inner layer, preferably over their entire surfaces, includes a third barrier layer. The third barrier layer may differ, for example in its material or its basis weight, from the first barrier layer or the second barrier layer or from both. Preferably, the third barrier layer has the same structure as the first barrier layer or the second barrier layer or both, i.e., in particular made of the same material and having the same basis weight.

In an embodiment 47 according to the invention, the liquid-tight container is designed according to one of its embodiments 43 to 46, wherein the third carrier layer has at least one through-hole which is covered at least with the third polymer inner layer. Alternatively or in addition to the third polymer inner layer, the at least one through-hole in the third carrier layer is covered with the third barrier layer. Preferably the further end element closes the liquid-tight container at a further end, wherein the further end is preferably a container head which is opposite a container bottom along the length of the liquid-tight container.

In an embodiment 48 according to the invention, the liquid-tight container is designed according to one of its embodiments 29 to 47, wherein the further end element is concavely or convexly curved with respect to the container interior.

In an embodiment 49 according to the invention, the liquid-tight container is designed according to one of its preceding embodiments, wherein the liquid-tight container, preferably the container wall, completely surrounds the container interior. In other words, the liquid-tight container is preferably closed.

In an embodiment 50 according to the invention, the liquid-tight container is designed according to one of its preceding embodiments, wherein the container interior contains a liquid. Preferably, the liquid is a foodstuff or a component of a foodstuff. Alternatively, the liquid is preferably a cosmetic product or a component of a cosmetic product. Preferably, the liquid, the foodstuff or the cosmetic product, occupies at least 50%, more preferably at least 60%, more preferably at least 70%, more preferably at least 80%, even more preferably at least 80%, most preferably at least 90%, of a volume of the container interior.

A contribution to achieving at least one of the objects according to the invention is made by an embodiment 1 of a method 1 for producing the liquid-tight container according to the invention according to one of its embodiments, the method including as method steps
a) providing
   i) a jacket element at least partially formed, preferably completely formed, from a first sheet-like material,
   ii) a first end element,
   iii) a first joining tool, and
   iv) a second joining tool,
   wherein the first sheet-like material
      comprises a first cardboard, and
      has a bending stiffness in a range from 50 to 600 mN, preferably from 50 to 500 mN, more preferably from 55 to 480 mN, more preferably from 60 to 460 mN, even more preferably from 65 to 440 mN, most preferably from 70 to 420 mN:
b) contacting
   i) the first end element with at least a first tool surface of the first joining tool, and
   ii) the jacket element with at least a second tool surface of the second joining tool; and
c) connecting the first end element to the jacket element with a material bond.

Preferred elements from which the liquid-tight container according to the invention is obtained according to method 1 are designed according to an embodiment of the method as described for an embodiment of the liquid-tight container according to the invention. Preferably but not necessarily, after method step c), the jacket element is flanged.

The first tool surface preferably forms at least 10%, more preferably at least 20%, more preferably at least 30%, more preferably at least 40%, more preferably at least 50%, more preferably at least 60%, more preferably at least 70%, more preferably at least 80%, even more preferably at least 90%, most preferably at least 95%, of exactly that part of a total surface of the first joining tool which, in method step b), faces the second joining tool and is contacted with the first end element. The second tool surface is preferably at least 10%, more preferably at least 20%, more preferably at least 30%, more preferably at least 40%, more preferably at least 50%, more preferably at least 60%, more preferably at least 70%, more preferably at least 80%, even more preferably at least 90%, most preferably at least 95%, of exactly that part of a total surface of the second joining tool which, in method step b), faces the first joining tool and is contacted with the jacket element. Preferably, the first tool surface or the second tool surface or either of the two is designed as a truncated cone surface or as a truncated pyramid surface.

Here, method steps of a method follow one another according to the order of their ordinal characters. Successive method steps can be carried out one after the other, in temporal overlap or simultaneously.

In an embodiment 2 according to the invention, the method 1 is designed according to its embodiment 1, wherein in method step b), preferably also in method step c), the first tool surface and the second tool surface form a first acute tool angle.

In an embodiment 3 according to the invention, the method 1 is designed according to its embodiment 2, wherein the first acute tool angle is in a range from 0.5 to 10°, preferably from 0.5 to 8°, more preferably from 0.5 to 6°, more preferably from 0.5 to 4°, even more preferably from 0.5 to 3°, most preferably from 1 to 2°.

In an embodiment 4 according to the invention, the method 1 is designed according to its embodiment 2 or 3, wherein a vertex of the first acute tool angle is arranged in the first direction after the legs of the first acute tool angle. The first acute tool angle thus forms here an arrowhead that points away from the container interior.

In an embodiment 5 according to the invention, the method 1 is designed according to one of its preceding embodiments, wherein in method step b), preferably also in method step c), the first tool surface forms an angle in a range from 5 to 20°, preferably from 6 to 18°, more preferably from 7 to 16°, even more preferably from 9 to 14°, most preferably from 10 to 12°, with a direction of the length of the jacket element. The direction of the length of the jacket element is preferably equal to a direction of a length of the liquid-tight container.

In an embodiment 6 according to the invention, the method 1 is designed according to one of its preceding embodiments, wherein in method step b), preferably also in method step c), the jacket element at least partially, preferably laterally completely, surrounds the first end element.

In an embodiment 7 according to the invention, the method 1 is designed according to one of its preceding embodiments, wherein in method step b), preferably also in method step c), the first joining tool is at least partially surrounded by the second joining tool. Alternatively or additionally, the first and the second joining tool are preferably in engagement with one another in method step b), preferably also in method step c).

In an embodiment 8 according to the invention, the method 1 is designed according to one of its preceding embodiments, wherein the first joining tool in method step c) oscillates at a frequency in a range from 15 to 50 kHz, preferably from 15 to 40 KHz, more preferably from 20 to 35 kHz. Alternatively or additionally, the first joining tool preferably oscillates in method step c) with an amplitude in a range from 3 to 60 μm, preferably from 5 to 50 μm, more preferably from 10 to 45 μm. A preferred first joining tool is a sonotrode. A preferred second joining tool is an anvil, which is designed as a counter tool to the sonotrode. The first joining tool is preferably designed in one piece. Alternatively or additionally preferably, the first joining tool is truncated pyramid-shaped or truncated cone-shaped. Alternatively or additionally preferably, the second joining tool is ring-shaped.

In an embodiment 9 according to the invention, the method 1 is designed according to one of its preceding embodiments, wherein the connecting with a material bond in method step c) is carried out by welding, preferably by friction welding.

In an embodiment 10 according to the invention, the method 1 is designed according to one of its preceding embodiments, wherein the first end element, relative to the length of the liquid-tight container, is arranged at a first end of the liquid-tight container: wherein the method further comprises a method step
d) closing the container at a further end opposite to the first end, relative to the length of the container.

Preferably, the first end element closes the container at the first end.

In an embodiment 11 according to the invention, the method 1 is designed according to its embodiment 10, wherein, after the closing in method step d), the container, preferably the container wall, completely surrounds the container interior.

In an embodiment 12 according to the invention, the method 1 is designed according to its embodiment 10 or 11, wherein
A) the first end is a container bottom and the further end is a container head: or
B) the first end is a container head and the further end is a container bottom.

In an embodiment 13 according to the invention, the method 1 is designed according to one of its embodiments 10 to 12, wherein the closing in method step d) is carried out with the jacket element, so that the jacket element delimits the container interior in a further direction opposite to the first direction. Here, in method step d), the container according to claim 28 is preferably obtained.

In an embodiment 14 according to the invention, the method 1 is designed according to its embodiment 13, wherein method step d) includes as sub-steps
i) folding the jacket element; and
ii) connecting regions of the jacket element to one another.

In an embodiment 15 according to the invention, the method 1 is designed according to one of its embodiments 10 to 12, wherein method step d) includes as sub-steps
i) contacting a further end element with at least a third tool surface of a third joining tool, and contacting the jacket element with at least a fourth tool surface of a fourth joining tool; and
ii) connecting the further end element to the jacket element with a material bond to obtain the container according to one of claims 29 to 50

The third tool surface preferably forms at least 10%, preferably at least 20%, more preferably at least 30%, more preferably at least 40%, more preferably at least 50%, more preferably at least 60%, more preferably at least 70%, more preferably at least 80%, even more preferably at least 90%, most preferably at least 95%, of exactly that part of a total surface of the third joining tool which, in method step d)i), faces the fourth joining tool and is contacted with the further end element. The fourth tool surface is preferably at least 10%, more preferably at least 20%, more preferably at least 30%, more preferably at least 40%, more preferably at least 50%, more preferably at least 60%, more preferably at least 70%, more preferably at least 80%, even more preferably at least 90%, most preferably at least 95%, of exactly that part of a total surface of the fourth joining tool which, in method step d)i), faces the third joining tool and is contacted with the jacket element. Preferably, the third tool surface or the fourth tool surface or either of the two is designed as a truncated cone surface or as a truncated pyramid surface.

In an embodiment 16 according to the invention, the method 1 is designed according to its embodiment 15, wherein in method step d)i), preferably also in method step d)ii), the third tool surface and the fourth tool surface form a further acute tool angle.

In an embodiment 17 according to the invention, the method 1 is designed according to its embodiment 16, wherein the further acute tool angle is in a range from 0.5 to 10°, preferably from 0.5 to 8°, more preferably from 0.5 to 6°, more preferably from 0.5 to 4°, even more preferably from 0.5 to 3°, most preferably from 1 to 2°.

In an embodiment 18 according to the invention, the method 1 is designed according to its embodiment 16 or 17, wherein a vertex of the further acute tool angle is arranged in the further direction after the legs of the further acute tool angle. The further acute tool angle thus forms here an arrowhead that points away from the container interior.

In an embodiment 19 according to the invention, the method 1 is designed according to one of its embodiments 15 to 18, wherein in method step d)i), preferably also in method step d)ii), the third tool surface forms an angle in a range from 5 to 20°, preferably from 6 to 18°, more preferably from 7 to 16°, even more preferably from 9 to 14°, most preferably from 10 to 12°, with a direction of the length of the open container.

In an embodiment 20 according to the invention, the method 1 is designed according to one of its embodiments 15 to 19, wherein in method step d)i), preferably also in method step d)ii), the jacket element at least partially, preferably laterally completely, surrounds the jacket element.

In an embodiment 21 according to the invention, the method 1 is designed according to one of its embodiments 15 to 20, wherein in method step d)i), preferably also in method step d)ii), the third joining tool is at least partially surrounded by the fourth joining tool. Alternatively or additionally, the third and fourth joining tools are preferably in engagement with one another in method step d)i), preferably also in method step d)ii).

In an embodiment 22 according to the invention, the method 1 is designed according to one of its embodiments 15 to 21, wherein the third joining tool in method step d)ii) oscillates at a frequency in a range from 15 to 50 kHz, preferably from 15 to 40 kHz, more preferably from 20 to 35 KHz. Alternatively or additionally, the third joining tool preferably oscillates in method step d)ii) with an amplitude in a range from 3 to 60 μm, preferably from 5 to 50 μm, more preferably from 10 to 45 μm. A preferred third joining tool is a sonotrode. A preferred fourth joining tool is an anvil, which is designed as a counter tool to the sonotrode. The third joining tool is preferably designed in one piece. Alternatively or additionally preferably, the third joining tool is truncated pyramid-shaped or truncated cone-shaped. Alternatively or additionally preferably, the fourth joining tool is ring-shaped.

In an embodiment 23 according to the invention, the method 1 is designed according to one of its embodiments 15 to 22, wherein the connecting with a material bond in method step d)ii) is carried out by welding, preferably by friction welding.

In an embodiment 24 according to the invention, the method 1 is designed according to one of its preceding embodiments, wherein the container
a} after method step c) and before method step d); or
b} after method step d): or
c} both
   is filled with a liquid. In case b} the container, preferably the jacket element, the first end element or the further end element, has a through-hole through which the filling takes place. After filling, the through-hole is preferably closed. For example, a pull tab can be applied, preferably glued or sealed. Preferably, the liquid is a foodstuff or a component of a foodstuff. Alternatively, the liquid is preferably a cosmetic product or a component of a cosmetic product. Preferably, after filling the container, the liquid, foodstuff or cosmetic product, occupies at least 50%, more preferably at least 60%, more preferably at least 70%, more preferably at least 80%, even more preferably at least 80%, most preferably at least 90%, of a volume of the container interior.

A contribution to achieving at least one of the objects according to the invention is made by an embodiment 1 of a method 2 for producing the liquid-tight container according to the invention according to one of its embodiments 28, 34, 49 and 50, the method including as method steps
a. providing
   i. a jacket element at least partially formed, preferably completely formed, from a first sheet-like material,
   ii. an end element,
   iii. a first joining tool, and
   iv. a second joining tool,
   wherein the first sheet-like material
      comprises a first cardboard, and
      has a bending stiffness in a range from 50 to 600 mN, preferably from 50 to 500 mN, more preferably from 55 to 480 mN, more preferably from 60 to 460 mN, even more preferably from 65 to 440 mN, most preferably from 70 to 420 mN;
b. closing the jacket element at one of its ends, relative to a length of the jacket element, thereby obtaining an open container;
c. contacting
   i. the end element with at least a first tool surface of the first joining tool, and
   ii. the jacket element with at least a second tool surface of the second joining tool; and
d. connecting the end element to the jacket element with a material bond.

Preferred elements from which the liquid-tight container according to the invention is obtained according to method 2 are, according to an embodiment of the method, designed as described for an embodiment of the liquid-tight container according to the invention. Preferably but not necessarily, after method step d., the jacket element is flanged.

The first tool surface preferably forms at least 10%, more preferably at least 20%, more preferably at least 30%, more preferably at least 40%, more preferably at least 50%, more preferably at least 60%, more preferably at least 70%, more preferably at least 80%, even more preferably at least 90%, most preferably at least 95%, of exactly that part of a total surface of the first joining tool which, in method step c., faces the second joining tool and is contacted with the end element. The second tool surface is preferably at least 10%, more preferably at least 20%, more preferably at least 30%, more preferably at least 40%, more preferably at least 50%, more preferably at least 60%, more preferably at least 70%, more preferably at least 80%, even more preferably at least 90%, most preferably at least 95%, of exactly that part of a total surface of the second joining tool which, in method step c., faces the first joining tool and is contacted with the jacket element. Preferably, the first tool surface or the second tool surface or either of the two is designed as a truncated cone surface or as a truncated pyramid surface.

The method steps of method 2 also follow one another according to the order of their ordinal characters. Successive method steps can be carried out one after the other, in temporal overlap or simultaneously.

In an embodiment 2 according to the invention, the method 2 is designed according to its embodiment 1, wherein in method step c., preferably also in method step d., the first tool surface and the second tool surface form an acute tool angle.

In an embodiment 3 according to the invention, the method 2 is designed according to its embodiment 2, wherein the acute tool angle is in a range from 0.5 to 10°, preferably from 0.5 to 8°, more preferably from 0.5 to 6°, more preferably from 0.5 to 4°, even more preferably from 0.5 to 3°, most preferably from 1 to 2°.

In an embodiment 4 according to the invention, the method 2 is designed according to its embodiment 2 or 3, wherein a vertex of the acute tool angle is arranged in the further direction after the legs of the acute tool angle. The acute tool angle thus forms here an arrowhead that points away from the container interior.

In an embodiment 5 according to the invention, the method 2 is designed according to one of its preceding embodiments, wherein in method step c., preferably also in method step d., the first tool surface forms an angle in a range of from 5 to 20°, preferably from 6 to 18°, more preferably from 7 to 16°, even more preferably from 9 to 14°, most preferably from 10 to 12°, with a direction of the length of the open container.

In an embodiment 6 according to the invention, the method 2 is designed according to one of its preceding embodiments, wherein the container obtained in method step d., preferably the container wall, completely surrounds the container interior.

In an embodiment 7 according to the invention, the method 2 is designed according to one of its preceding embodiments, wherein in method step c., preferably also in method step d., the jacket element at least partially, preferably laterally completely, surrounds the end element.

In an embodiment 8 according to the invention, the method 2 is designed according to one of its preceding embodiments, wherein in method step c., preferably also in method step d., the first joining tool is at least partially surrounded by the second joining tool. Alternatively or additionally, the first and the second joining tool are preferably in engagement with one another in method step c., preferably also in method step d.

In an embodiment 9 according to the invention, the method 2 is designed according to one of its preceding embodiments, wherein the method step b. includes as sub-steps
i. folding the jacket element; and
ii. connecting regions of the jacket element to one another.

In an embodiment 10 according to the invention, the method 2 is designed according to one of its preceding embodiments, wherein the first joining tool in method step d. oscillates at a frequency in a range from 15 to 50 kHz, preferably from 15 to 40 KHz, more preferably from 20 to 35 kHz. Alternatively or additionally, the first joining tool preferably oscillates in method step d. with an amplitude in a range from 3 to 60 μm, preferably from 5 to 50 μm, more preferably from 10 to 45 μm. A preferred first joining tool is a sonotrode. A preferred second joining tool is an anvil, which is designed as a counter tool to the sonotrode. The first joining tool is preferably designed in one piece. Alternatively or additionally preferably, the first joining tool is truncated pyramid-shaped or truncated cone-shaped. Alternatively or additionally preferably, the second joining tool is ring-shaped.

In an embodiment 11 according to the invention, the method 2 is designed according to one of its preceding embodiments, wherein the connecting with a material bond in method step d. is carried out by welding, preferably by friction welding.

In an embodiment 12 according to the invention, the method 2 is designed according to one of its preceding embodiments, wherein
a] the open container after method step b. and before method step c.; or
b] the container after method step d.; or
c] both
   is filled with a liquid. In case b] the container, preferably the jacket element or the end element, has a through-hole through which filling takes place. After filling, the through-hole is preferably closed. For example, a pull tab can be applied, preferably glued or sealed. Preferably, the liquid is a foodstuff or a component of a foodstuff. Alternatively, the liquid is preferably a cosmetic product or a component of a cosmetic product. Preferably, after filling the container, the liquid, foodstuff or cosmetic product, occupies at least 50%, more preferably at least 60%, more preferably at least 70%, more preferably at least 80%, even more preferably at least 80%, most preferably at least 90%, of a volume of the container interior.

A contribution to achieving at least one of the objects according to the invention is made by an embodiment 1 of a device for producing a container in a method stream, the device including as components
a] a first closing apparatus comprising a first joining tool and a second joining tool; and
b] a further closing apparatus arranged downstream of the first closing apparatus, comprising a third joining tool and a fourth joining tool;
   wherein
A. the first closing apparatus is designed and set up to carry out the method steps b) and c), and the further closing apparatus is designed and set up to carry out the method step d), in each case of the method 1 according to one of its embodiments 10 to 24; or
B. the first closing apparatus is designed and set up to carry out the method step b., and the further closing apparatus is designed and set up to carry out the method steps c. and d., in each case of the method 2 according to one of its embodiments.

In a preferred embodiment, the device is designed and set up to carry out method 1 or 2, in each case according to one of its embodiments. Preferably, the first closing apparatus according to the above alternative A. is designed and set up in addition for a flanging of the jacket element at the first end. According to alternative A., the first closing apparatus is preferably designed and set up in addition for flanging the jacket element around an edge of the first end element, or the further closing apparatus is preferably designed and set up in addition for flanging the jacket element around an edge of the further end element, or both. According to alternative B., the further closing apparatus is preferably designed and set up in addition for flanging the jacket element around an edge of the end element.

In an embodiment 2 according to the invention, the device is designed according to its embodiment 1, wherein the device additionally includes a filling apparatus, wherein the filling apparatus
i] is arranged between the first closing apparatus and the further closing apparatus, and is arranged and designed to fill the open container with a foodstuff; or
ii] is arranged downstream of the further closing apparatus and is arranged and designed to fill the container with a foodstuff.

In an embodiment 3 according to the invention, the device is designed according to its embodiment 1 or 2, wherein the device is a filling machine.

A contribution to achieving at least one of the objects of the invention is made by an embodiment 1 of a use 1 of the container according to the invention according to one of its embodiments for storing or transporting a liquid. Preferably, the liquid is a foodstuff or a component of a foodstuff. Alternatively, the liquid is preferably a cosmetic product or a component of a cosmetic product.

A contribution to achieving at least one of the objects of the invention is made by an embodiment 1 of a use 2 of a sheet-like composite for producing the container according to the invention according to one of its embodiments: wherein one selected from the group consisting of the jacket element, the first end element, and the further end element, or a combination of at least two thereof is formed at least partially, preferably completely, from the sheet-like composite. In a preferred embodiment of use 2, one selected from the group consisting of the jacket element, the first end element, and the further end element, or a combination of at least two thereof is designed as described for an embodiment of the container according to the invention. A preferred sheet-like composite has a bending stiffness in a range from 50 to 600 mN, preferably from 50 to 500 mN, more preferably from 55 to 480 mN, more preferably from 60 to 460 mN, even more preferably from 65 to 440 mN, most preferably from 70 to 420 mN.

In an embodiment 2 according to the invention, the use 2 is designed according to its embodiment 1, wherein the sheet-like composite comprises a layer sequence of layers overlaid on one another; wherein the layer sequence comprises a carrier layer.

In an embodiment 3 according to the invention, the use 2 is designed according to its embodiment 2, wherein the carrier layer comprises, preferably consists of, one selected from the group consisting of cardboard, paperboard, and paper, or a combination of at least two thereof. A preferred cardboard has a basis weight in a range from 50 to 500 g/m², preferably from 100 to 500 g/m², more preferably from 100 to 450 g/m², more preferably from 150 to 450 g/m², even more preferably from 170 to 420 g/m², most preferably from 190 to 400 g/m².

In an embodiment 4 according to the invention, the use 2 is designed according to its embodiment 2 or 3, wherein the carrier layer in the layer sequence is overlaid on a first side with a polymer inner layer.

In an embodiment 5 according to the invention, the use 2 is designed according to its embodiment 4, wherein the carrier layer in the layer sequence is overlaid with a polymer outer layer on a further side opposite the first side.

In an embodiment 6 according to the invention, the use 2 is designed according to its embodiment 4 or 5, wherein the layer sequence between the carrier layer and the polymer inner layer includes a barrier layer.

In an embodiment 7 according to the invention, the use 2 is designed according to one of its embodiments 2 to 6, wherein the carrier layer has at least one through-hole which is covered at least by the polymer inner layer. Alternatively or in addition to the polymer inner layer, the at least one through-hole in the carrier layer is covered with the barrier layer.

A contribution to achieving at least one of the objects according to the invention is made by an embodiment 1 of a use 3 of a first joining tool and a second joining tool for forming a container bottom or a container head of a container by means of
a} contacting
   i} a first end element with at least a first tool surface of the first joining tool, and
   ii} a jacket element with at least a second tool surface of the second joining tool, and
b} connecting the first end element to the jacket element with a material bond thereby obtaining the container according to the invention according to one of its embodiments.

The first tool surface preferably forms at least 10%, more preferably at least 20%, more preferably at least 30%, more preferably at least 40%, more preferably at least 50%, more preferably at least 60%, more preferably at least 70%, more preferably at least 80%, even more preferably at least 90%, most preferably at least 95%, of exactly that part of a total surface of the first joining tool which, according to the use, faces the second joining tool and is contacted with the first end element. The second tool surface is preferably at least 10%, more preferably at least 20%, more preferably at least 30%, more preferably at least 40%, more preferably at least 50%, more preferably at least 60%, more preferably at least 70%, more preferably at least 80%, even more preferably at least 90%, most preferably at least 95%, of exactly that part of a total surface of the second joining tool which, according to the use, faces the first joining tool and is contacted with the jacket element. Preferably, the first tool surface or the second tool surface or either of the two is designed as a truncated cone surface or as a truncated pyramid surface. In a preferred embodiment of the use 3, step a} is carried out according to a step selected from the group consisting of step b) of method 1, step di) described for embodiment 15 of method 1, and step c. of method 2, or according to multiple thereof. Alternatively or additionally, step b} is preferably carried out according to a step selected from the group consisting of step c) of method 1, step dii) described for embodiment 15 of method 1, and step d. of method 2, or according to multiple thereof.

Features described as preferred in a category according to the invention, e.g., according to the container according to the invention, are likewise preferred in one embodiment of the further categories according to the invention—for example, an embodiment of the method 1 or 2 according to the invention or the uses 1 to 3 according to the invention. Furthermore, the features described below are preferred in connection with each category.

### Container

The container according to the invention is preferably a foodstuff container. Preferably, the interior of a container according to the invention contains a foodstuff. The container wall is preferably waterproof. Furthermore, the container is preferably dimensionally stable. This means that the container wall substantially retains its shape when filled. A variety of different shapes of the container wall is conceivable here. Preferably, the container wall has, at least in portions, preferably at least in the region of the container head or the container bottom or both, even more preferably substantially completely, substantially a shape of a prism or a cylinder. A preferred prism here is a straight prism or an oblique prism. Alternatively or additionally preferably the prism is regular or non-regular. The term “substantially a shape” here means that the container wall or the corresponding portion thereof does not have to have the shape of a geometrically exact prism or a geometrically exact cylinder. For example, the polygon that forms a base of the prism may have rounded corners, so that the prism has rounded edges. Herein, a container wall having such a shape also substantially has the shape of a prism. Another preferred container has a container wall which, at least in portions, preferably at least in the region of the container head or the container bottom or both, even more preferably substantially completely, has the shape of a geometric body which can be obtained by parallel displacement of a flat base with a rounded shape. A preferred flat base with a rounded shape is kidney-shaped.

The container wall can be made of different materials. It is conceivable here that in addition to sheet-like materials, in particular sheet-like composites, other materials are also used, for example one or more molded parts made of plastic. Such molded parts can be used in particular in the container head or container bottom. However, it is preferred here that the container wall consists to an extent of at least 50%, more preferably at least 60%, more preferably at least 70%, particularly preferably at least 80%, and furthermore preferably at least 90%, of its surface facing away from the container interior (outer surface) of one or more sheet-like materials, in particular sheet-like composites. Alternatively or additionally, at least 50%, more preferably at least 60%, more preferably at least 70%, particularly preferably at least 80%, and further preferably at least 90%, of the outer surface of the container wall is formed by the jacket element and the first and/or further end element.

The container according to the invention is preferably a closed container. The container may have a device for emptying the contents (opening aid). This can, for example, be formed from a polymer or a mixture of polymers and attached to the outside of the container. It is also conceivable that this device is integrated into the container by “direct injection molding”.

### Jacket Element

The jacket element forms a region of the container wall of the container according to the invention. This region is preferably a lateral region of the container wall, i.e., a region of the container wall which, relative to the length of the container, is lateral. Accordingly, the jacket element laterally delimits the container interior. The region of the container wall formed by the jacket element preferably has the form of a lateral surface of a prism or a cylinder. A preferred prism here is a straight prism or an oblique prism. Alternatively or additionally preferably the prism is regular or non-regular. The jacket element includes a first sheet-like material, preferably the jacket element consists thereof. Here, the first sheet-like material preferably has a first edge and an opposite further edge, wherein the first edge and the further edge are connected to one another, preferably sealed. A preferred jacket element is formed in one piece.

### End Element

The first end element is preferably a lid element or a bottom element. If the first end element is a lid element and the container comprises a further end element, the further end element is preferably a bottom element. If the first end element is a bottom element and the container comprises a further end element, the further end element is preferably a lid element. If the container wall has the shape of a prism or cylinder, the first end element and, if present, preferably also the further end element each form an end face of the prism or cylinder. The first end element delimits the container interior in a first direction along the length of the container. If present, the further end element delimits the container interior in a direction opposite to the first direction. In other words, the first end element and the further end element axially delimit the container interior. The region of the container wall formed by the first end element preferably has the form of a polygonal surface or a circular surface. Alternatively or additionally preferably, the region of the container wall formed by the further end element has the form of a polygonal surface or a circular surface. A preferred polygonal surface is a surface of a regular polygon or a non-regular polygon.

A preferred first end element is formed in one piece or has no connection point, in particular no seam, or both. Alternatively or additionally preferably, the further end element is formed in one piece or has no connection point, in particular no seam, or both.

### Joining Element

The following statements about “the joining element” refer in each case to the first joining element or the further joining element or to both. The joining element is preferably formed substantially from a polymer or a polymer mixture. The term “substantially” means here in particular that the joining element can also comprise gas inclusions, such as air bubbles. Preferred polymers and polymer blends are those listed below. With respect to the jacket element and the first end element and, if applicable, the further end element, the joining element may be an additional element of the container which has been additionally introduced into the container, for example as a sealing agent. Preferably, however, the first joining element is formed from at least one polymer layer, preferably at least the polymer inner layer, of the jacket element or of the first end element or from both. The further joining element is preferably formed from at least one polymer layer, preferably at least the polymer inner layer, of the jacket element or of the further end element or from both. For this purpose, it is possible that the at least one polymer layer was softened or melted in regions and the joining element can have been formed from the softened or melted polymer. Accordingly, the at least one polymer layer in the container can continuously merge into the joining element. A preferred first joining element is ring-shaped. A cross-sectional area, preferably each cross-sectional area of the ring-shaped first joining element has the first acute angle. A preferred further joining element is ring-shaped. A cross-sectional area, preferably each cross-sectional area of the ring-shaped further joining element has the further acute angle. The above-mentioned cross-sectional areas are preferably triangular or trapezoidal areas. A preferred joining element is wedge-shaped. Preferably, the first joining element is arranged between the jacket element and the first end element, wherein the first joining element is preferably arranged laterally circumferentially around the jacket element or more preferably around the first end element. The further joining element is preferably arranged between the jacket element and the further end element, wherein the further joining element is preferably arranged laterally circumferentially around the jacket element or more preferably around the further end element.

### Sheet-Like Material/Sheet-Like Composite

In the following, “the sheet-like material” refers to each of the first to third sheet-like materials. Likewise, the “sheet-like composite” refers to each of the first to third sheet-like composites. All flat materials in particular in sheet form, in particular laminates, which are conceivable within the scope of the invention and which appear suitable to a person skilled in the art for use according to the invention for producing dimensionally stable foodstuff containers can be considered as sheet-like material. The sheet-like material preferably comprises a carrier layer. In a preferred embodiment of the invention, the carrier layer is overlaid on one side with a color application, preferably is printed. In a further preferred embodiment, the sheet-like material is present as a sheet-like composite. Sheet-like composites for producing foodstuff containers are also called laminates. Such sheet-like composites have a sequence of layers superimposed on one another in a sheet-like manner. The sheet-like composites are often made up of a thermoplastic polymer layer, which is referred to herein as the polymer outer layer, a carrier layer, usually made of cardboard or paper, which gives the container its dimensional stability, an optional thermoplastic polymer layer, which is referred to herein as the polymer intermediate layer, and/or an optional adhesion promoter layer, a barrier layer and a further thermoplastic polymer layer, which is referred to herein as the polymer inner layer. The layers forming the layer sequence of the sheet-like composite are preferably connected to one another in a planar manner. Two layers are connected to one another if their adhesion to one another goes beyond Van der Waals forces of attraction. Layers connected to one another are preferably one selected from the group consisting of sealed to one another, glued to one another and pressed to one another, or a combination of at least two thereof. Unless otherwise stated, the layers in a layer sequence can follow one another indirectly, i.e. with one or at least two intermediate layers, or directly, i.e. without an intermediate layer. This is particularly the case with formulations where one layer overlays another layer. A formulation in which a layer sequence includes enumerated layers means that at least the specified layers are present in the specified order. This formulation does not necessarily mean that these layers follow one another directly. A formulation in which two layers are adjacent to one another means that these two layers follow one another directly and thus without an intermediate layer. However, this formulation says nothing about whether the two layers are connected or not. Rather, these two layers can be in contact with one another. Preferably, however, these two layers are connected to one another, preferably in a planar manner. The first to third sheet-like materials mentioned in the context of the invention, in particular the first to third sheet-like composites, can be constructed identically to or differently from one another. In a preferred embodiment, the second and third sheet-like materials have the same structure. In a further preferred embodiment, the first and second sheet-like materials have the same structure. In a further preferred embodiment, the first and third sheet-like materials have the same structure. In a particularly preferred embodiment, the first to third sheet-like materials have the same structure.

### Polymer Layers

In the following, the term “polymer layer” refers particularly to the polymer inner layer, the polymer intermediate layer and the polymer outer layer. The polymer layers are each based on a polymer or a polymer mixture. A preferred polymer is a thermoplastic polymer, more preferably a polyolefin. The polymer layers are preferably incorporated or applied into the sheet-like composite material in an extrusion process, preferably by layer extrusion. In addition to the polymer or polymer mixture, each polymer layer may comprise additional components. The other components of the polymer layers are preferably components that do not adversely affect the behavior of the polymer melt when applied as a layer. The other components can be, for example, inorganic compounds such as metal salts or other plastics such as other thermoplastics. Suitable polymers for the polymer layers are particularly those that are easy to process due to good extrusion behavior. Suitable polymers are those obtained by chain polymerization, in particular polyolefins, wherein cyclic olefin copolymers (COC), polycyclic olefin copolymers (POC), in particular polyethylene and polypropylene, are particularly preferred, and polyethylene is very particularly preferred. Among the polyethylenes, HDPE (high density polyethylene), MDPE (medium density polyethylene), LDPE (low density polyethylene), LLDPE (linear low density polyethylene) and VLDPE (very low density polyethylene) and mixtures of at least two of these are preferred. Suitable polymer layers have a melt flow rate (MFR—melt flow rate) in a range from 1 to 25 g/10 min, preferably in a range from 2 to 20 g/10 min and particularly preferably in a range from 2.5 to 15 g/10 min, and a density in a range from 0.890 g/cm³ to 0.980 g/cm³, preferably in a range from 0.895 g/cm³ to 0.975 g/cm³, and further preferably in a range from 0.900 g/cm³ to 0.970 g/cm³. The polymer layers preferably have at least one melting temperature in a range from 80 to 155° C., preferably in a range from 90 to 145° C. and particularly preferably in a range from 95 to 135° C.

### Polymer Inner Layer

The polymer inner layer is based on at least one thermoplastic polymer, wherein the polymer inner layer may comprise a particulate inorganic solid. However, it is preferred that the polymer inner layer comprises at least 70% by weight, preferably at least 80% by weight and particularly preferably at least 95% by weight, in each case based on the total weight of the polymer inner layer, of one or more thermoplastic polymers. Preferably, the polymer or polymer mixture of the polymer inner layer has a density (according to ISO 1183-1:2004) in a range from 0.900 to 0.980 g/cm³, particularly preferably in a range from 0.900 to 0.960 g/cm³ and most preferably in a range from 0.900 to 0.940 g/cm³. Preferably the polymer is a polyolefin. The polymer inner layer preferably comprises a polyethylene or a polypropylene or both. A particularly preferred polyethylene is a LDPE.

### Polymer Outer Layer

The polymer outer layer preferably comprises a polyethylene or a polypropylene or both. LDPE and HDPE as well as mixtures of these are preferred as polyethylene. A preferred polymer outer layer comprises at least 50% by weight, preferably at least 60% by weight, more preferably at least 70% by weight, even more preferably at least 80% by weight, most preferably at least 90% by weight, in each case based on the weight of the polymer outer layer, of a LDPE.

### Polymer Intermediate Layer

The polymer intermediate layer preferably comprises a polyethylene or a polypropylene or both. A particularly preferred polyethylene is a LDPE. Preferably, the polymer intermediate layer comprises the polyethylene or the polypropylene or both together in a proportion of at least 20% by weight, more preferably at least 30% by weight, more preferably at least 40% by weight, more preferably at least 50% by weight, more preferably at least 60% by weight, more preferably at least 70% by weight, more preferably at least 80% by weight, most preferably at least 90% by weight, in each case based on the total weight of the polymer intermediate layer.

### Barrier Layer

Any material known by a person skilled in the art to be suitable for this purpose which has a sufficient barrier effect, in particular against oxygen, can be used as a barrier layer. For this purpose, the barrier layer preferably has an oxygen permeation rate of less than 50 cm³/(m²·day·atm), preferably less than 40 cm³/(m²·day·atm), preferably less than 30 cm³/(m²·day·atm), preferably less than 20 cm³/(m²·day·atm), preferably less than 10 cm³/(m²·day·atm), even more preferably less than 3 cm³/(m²·day·atm), most preferably not more than 1 cm³/(m²·day·atm). The barrier layer preferably also has a barrier effect against water vapor. Accordingly, the barrier layer is preferably an oxygen barrier layer and further preferably additionally a water vapor barrier layer. In addition, the barrier layer preferably has a barrier effect against visible light, i.e. it is also a light barrier layer.

The barrier layer is preferably selected from
a. a plastic barrier layer;
b. a metal layer;
c. an oxide layer: or
d. a combination of at least two from a. to c.

If the barrier layer according to alternative a. is a plastic barrier layer, it preferably comprises at least 70% by weight, particularly preferably at least 80% by weight and most preferably at least 95% by weight of at least one plastic which is known to the person skilled in the art for this purpose, in particular because of aroma or gas barrier properties suitable for packaging containers. As plastics, in particular thermoplastics, N or O-bearing plastics can be considered here, both alone and in mixtures of two or more. According to the invention, it may prove advantageous if the plastic barrier layer has a melting temperature in a range from more than 155 to 300° C., preferably in a range from 160 to 280° C. and particularly preferably in a range from 170 to 270° C.

More preferably, the plastic barrier layer has a basis weight in a range from 2 to 120 g/m², preferably in a range from 3 to 60 g/m², particularly preferably in a range from 4 to 40 g/m² and further preferably from 6 to 30 g/m². Furthermore, the plastic barrier layer is preferably obtainable from melts, for example by extrusion, in particular layer extrusion. Furthermore, the plastic barrier layer can also preferably be introduced into the sheet-like composite via lamination. Here, it is preferred that a film is incorporated into the sheet-like composite. According to another embodiment, plastic barrier layers can also be selected which are obtainable by deposition from a solution or dispersion of plastics.

Suitable polymers are preferably those which have a weight-average molecular weight, determined by gel permeation chromatography (GPC) using light scattering, in a range from 3·10³ up to 1·10⁷ g/mol, preferably in a range from 5·10³ up to 1·10⁶ g/mol and particularly preferably in a range from 6·10³ up to 1·10⁵ g/mol. Suitable polymers include polyamide (PA) or polyethylene vinyl alcohol (EVOH) or a mixture thereof.

Among the polyamides, all PAs that appear suitable to a person skilled in the art for use according to the invention are suitable.

All EVOHs that appear suitable to a person skilled in the art for use according to the invention may be considered as EVOH. Examples of this are commercially available under the trade names EVAL™ from EVAL Europe NV, Belgium in a variety of different versions, for example the varieties EVAL™ F104B or EVAL™ LR171B. Preferred EVOHs have at least one, two, multiple or all of the following properties:
an ethylene content in a range from 20 to 60 mol %, preferably from 25 to 45 mol %;
a density in a range from 1.0 to 1.4 g/cm³, preferably from 1.1 to 1.3 g/cm³;
a melting point in a range from more than 155 to 235° C., preferably from 165 to 225° C.;
an MFR value (210° C./2.16 kg, if T_{S(EVOH)}<210° C.; 230° C./2.16 kg if 210° C.<T_{S(EVOH)}<230° C.) in a range from 1 to 25 g/10 min, preferably from 2 to 20 g/10 min;
an oxygen permeation rate in a range from 0.05 to 3.2 cm³·20 μm/(m²·day·atm), preferably in a range from 0.1 to 1 cm³·20 μm/(m²·day·atm).

Preferably, at least one polymer layer, more preferably the polymer inner layer, or preferably all polymer layers have a melting temperature below the melting temperature of the barrier layer. This is especially true if the barrier layer is made of polymer. In this case, the melting temperatures of the at least one, in particular the polymer inner layer, and the melting temperature of the barrier layer preferably differ by at least 1 K, particularly preferably by at least 10 K, even more preferably by at least 50 K, furthermore preferably at least 100 K. The temperature difference should preferably only be selected to be so high that it does not lead to melting of the barrier layer, in particular not to melting of the plastic barrier layer, during folding.

According to alternative b., the barrier layer is a metal layer. In principle, all layers with metals that are known to a person skilled in the art and can provide a high level of light and oxygen impermeability are suitable as metal layers. According to a preferred embodiment, the metal layer can be present as a foil or as a deposited layer, e.g. after physical vapor deposition. The metal layer is preferably a continuous layer. According to a further preferred embodiment, the metal layer has a thickness in a range from 3 to 20 μm, preferably in a range from 3.5 to 12 μm and particularly preferably in a range from 4 to 10 μm.

Preferred selected metals are aluminum, iron or copper. As an iron layer, a steel layer, e.g. in the form of a foil, may be preferred. Furthermore, the metal layer preferably represents a layer with aluminum. The aluminum layer can suitably consist of an aluminum alloy, for example AlFeMn, AlFe1.5Mn, AlFeSi or AlFeSiMn. The purity is usually 97.5% and higher, preferably 98.5% and higher, based on the entire aluminum layer. In a special design, the metal layer consists of an aluminum foil. Suitable aluminum foils have an extensibility of more than 1%, preferably more than 1.3% and particularly preferably more than 1.5%, and a tensile strength of more than 30 N/mm², preferably more than 40 N/mm² and particularly preferably more than 50 N/mm². Suitable aluminum foils show a drop size of more than 3 mm, preferably more than 4 mm and particularly preferably more than 5 mm in the pipette test. Suitable alloys for producing aluminum layers or foils are commercially available under the names EN AW 1200, EN AW 8079 or EN AW 8111 from Hydro Aluminium Deutschland GmbH or Amcor Flexibles Singen GmbH. In the case of a metal foil as barrier layer, an adhesion promoter layer can be provided on one and/or both sides of the metal foil between the metal foil and a nearest polymer layer.

Furthermore, an oxide layer can preferably be selected as the barrier layer according to alternative c. Oxide layers that are familiar to a person skilled in the art and that appear suitable for achieving a barrier effect against light, vapor and/or gas can be considered as oxide layers. A preferred oxide layer is a semi-metal oxide layer or a metal oxide layer or both. A preferred semi-metal oxide layer is a layer based on one or more silicon oxide compounds (SiOx layer). Preferred metal oxide layers are layers based on the previously mentioned metals aluminum, iron or copper, as well as metal oxide layers based on titanium oxide compounds, with an aluminum oxide layer (AlOx layer) being particularly preferred. According to a preferred embodiment, the oxide layer may be present as a deposited layer. A deposited oxide layer is produced, for example, by vapor-depositing a barrier substrate with the oxide layer. A preferred method for this is physical vapor deposition (PVD) or, preferably plasma-assisted, chemical vapor deposition (CVD). The oxide layer is preferably a continuous layer.

The barrier substrate may consist of any material which appears to a person skilled in the art suitable for use as a barrier substrate according to the invention. The barrier substrate is preferably suitable for being coated with an oxide layer. Preferably, a layer surface is sufficiently smooth for this purpose. Further preferably, the barrier substrate has a thickness in a range from 3 to 30 μm, preferably from 2 to 28 μm, more preferably from 2 to 26 μm, more preferably from 3 to 24 μm, more preferably from 4 to 22 μm, most preferably from 5 to 20 μm. Furthermore, the barrier substrate preferably has a barrier effect against oxygen or water vapor or both. Preferably, a barrier effect of the barrier substrate against permeation of oxygen is greater than a barrier effect of the oxide layer against permeation of oxygen. Preferably, the barrier substrate has an oxygen permeation rate in a range from 0.1 to 50 cm³/(m²·d·bar), preferably from 0.2 to 40 cm³/(m²·d·bar), preferably from 0.3 to 30 cm³/m²·d·bar). A preferred barrier substrate comprises, more preferably consists of, cellulose or a polymer or both. A preferred polymer here is an oriented polymer. Preferably, the oriented polymer is mono-axially oriented or bi-axially oriented. A further preferred polymer is a thermoplastic polymer. Preferably, the barrier substrate consists of the polymer. Preferably, the barrier substrate includes a polymer selected from the group consisting of a polycondensate, a polyethylene, a polypropylene, a polyvinyl alcohol, or a combination of at least two thereof in a proportion of at least 50% by weight, preferably at least 60% by weight, more preferably at least 70% by weight, more preferably at least 80% by weight, most preferably at least 90% by weight, in each case based on the weight of the barrier substrate. Preferably, the barrier substrate consists of the aforementioned polymer. A preferred polypropylene is oriented, in particular longitudinally stretched (oPP) or biaxially stretched (BoPP). A preferred polycondensate is a polyester or polyamide (PA) or both. A preferred polyester is one selected from the group consisting of a polyethylene terephthalate (PET), a polylactide (PLA), and, or a combination of at least two thereof. A preferred vinyl polymer is a vinyl alcohol copolymer or a polyvinyl alcohol or both. A preferred polyvinyl alcohol is a vinyl alcohol copolymer. A preferred vinyl alcohol copolymer is an ethylene-vinyl alcohol copolymer.

### Carrier Layer

Any material known to be suitable for this purpose by a person skilled in the art which has sufficient strength and rigidity to give the container stability to such an extent that the container substantially retains its shape when filled can be used as the carrier layer. This is a particularly necessary feature of the carrier layer since the invention relates to the technical field of dimensionally stable containers. Such dimensionally stable containers must be fundamentally distinguished from bags and pouches, which are usually made of thin foil. In addition to a range of plastics, plant-based fiber materials, in particular cellulose, preferably glued, bleached and/or unbleached cellulose are preferred, with paper and cardboard being particularly preferred. Accordingly, a preferred carrier layer comprises a plurality of fibers. The basis weight of the carrier layer is preferably in a range from 120 to 450 g/m², particularly preferably in a range from 130 to 400 g/m² and most preferably in a range from 150 to 380 g/m². A preferred cardboard usually has a single- or multi-layer structure and can be coated on one or both sides with one or more cover layers. Furthermore, a preferred cardboard has a residual moisture content of less than 20% by weight, preferably from 2 to 15% by weight and particularly preferably from 4 to 10% by weight, based on the total weight of the cardboard. A particularly preferred cardboard has a multi-layer structure. Furthermore, the cardboard preferably has at least one, but particularly preferably at least two plies of a cover layer on the surface facing the environment, which is known to the person skilled in the art as a “paper coating”. Furthermore, a preferred board has a Scott Bond value (according to Tappi 569) in a range from 100 to 360 J/m², preferably from 120 to 350 J/m² and particularly preferably from 135 to 310 J/m². The above-mentioned ranges make it possible to provide a composite from which a container with high tightness can be folded easily and with small tolerances.

The carrier layer is characterized by bending stiffness. The carrier layer preferably has a bending stiffness in a range from 80 to 550 mN in a first direction. In the case of a carrier layer which comprises a plurality of fibers, the first direction is preferably an orientation direction of the fibers. A carrier layer comprising a plurality of fibers further preferably has a bending stiffness in a range from 20 to 300 mN in a second direction perpendicular to the first direction. A preferred sheet-like composite with the carrier layer has a bending stiffness in the first direction in a range from 100 to 700 mN. Furthermore, the aforementioned sheet-like composite preferably has a bending stiffness in the second direction in a range from 50 to 500 mN.

### Polyolefin

A preferred polyolefin is a polyethylene (PE) or a polypropylene (PP) or both. A preferred polyethylene is one selected from the group consisting of an LDPE, an LLDPE, and an HDPE, or a combination of at least two thereof. Another preferred polyolefin is an mpolyolefin (polyolefin produced using a metallocene catalyst). Suitable polyethylenes have a melt flow rate (MFI—Melt Flow Index=MFR−melt flow rate) in a range from 1 to 25 g/10 min, preferably in a range from 2 to 20 g/10 min and particularly preferably in a range from 2.5 to 15 g/10 min, and a density in a range from 0.910 g/cm³ to 0.935 g/cm³, preferably in a range from 0.912 g/cm³ to 0.932 g/cm³, and further preferably in a range from 0.915 g/cm³ to 0.930 g/cm³.

### Mpolymer

An mpolymer is a polymer that has been produced using a metallocene catalyst. A metallocene is an organometallic compound in which a central metal atom is arranged between two organic ligands, such as cyclopentadienyl ligands. A preferred mpolymer is a mpolyolefin, preferably a mpolyethylene or a mpolypropylene or both. A preferred mpolyethylene is one selected from the group consisting of an mLDPE, an mLLDPE, and an mHDPE, or a combination of at least two thereof. A preferred mpolyolefin is characterized by at least a first melting temperature and a second melting temperature. Preferably, the mpolyolefin is characterized by a third melting temperature in addition to the first and second melting temperatures. A preferred first melting temperature is in a range from 84 to 108° C., preferably from 89 to 103° C., more preferably from 94 to 98° C. A preferred further melting temperature is in a range from 100 to 124° C., preferably from 105 to 119° C., more preferably from 110 to 114° C.

### Adhesion/Adhesion Promoter Layer

An adhesion promoter layer is a layer of the sheet-like composite which comprises at least one adhesion promoter in a sufficient amount so that the adhesion promoter layer improves adhesion between layers adjacent to the adhesion promoter layer. For this purpose, the adhesion promoter layer preferably comprises an adhesion promoter polymer. Accordingly, the adhesion promoter layers are preferably polymer layers. An adhesion promoter layer can be located between layers of the sheet-like composite which do not directly adjoin one another, preferably between the barrier layer and the polymer inner layer. All plastics that are suitable for functionalization using suitable functional groups to create a permanent connection by forming ionic bonds or covalent bonds to a surface of an adjacent layer can be used as adhesion promoters in an adhesion promoter layer. Preferably, they are functionalized polyolefins, in particular acrylic acid copolymers, which have been obtained by copolymerization of ethylene with acrylic acids such as acrylic acid, methacrylic acid, crotonic acid, acrylates, acrylate derivatives or carboxylic acid anhydrides with double bonds, for example maleic anhydride, or at least two thereof. Among these, polyethylene-maleic anhydride graft polymers (EMAH), ethylene-acrylic acid copolymers (EAA) or ethylene-methacrylic acid copolymers (EMAA) are preferred, which are distributed, for example, under the trade names Bynel® and Nucrel®0609HSA by DuPont or Escor®6000ExCo by ExxonMobile Chemicals.

Ethylene-alkyl acrylate copolymers are also preferred as adhesion promoters. The alkyl group preferably selected is a methyl, ethyl, propyl, i-propyl, butyl, i-butyl or a pentyl group. More preferably, the adhesion promoter layer may comprise mixtures of two or more different ethylene-alkyl acrylate copolymers. Also preferably, the ethylene alkyl acrylate copolymer may have two or more different alkyl groups in the acrylate function, e.g. an ethylene alkyl acrylate copolymer in which both methyl acrylate units and ethyl acrylate units occur in the same copolymer.

According to the invention, it is preferred that the adhesion between the carrier layer, a polymer layer or the barrier layer to the next layer is at least 0.5 N/15 mm, preferably at least 0.7 N/15 mm and particularly preferably at least 0.8 N/15 mm. In an embodiment according to the invention, it is preferred that the adhesion between a polymer layer and a carrier layer is at least 0.3 N/15 mm, preferably at least 0.5 N/15 mm and particularly preferably at least 0.7 N/15 mm. Furthermore, it is preferred that the adhesion between the barrier layer and a polymer layer is at least 0.8 N/15 mm, preferably at least 1.0 N/15 mm and particularly preferably at least 1.4 N/15 mm. In the event that the barrier layer indirectly follows a polymer layer via an adhesion promoter layer, it is preferred that the adhesion between the barrier layer and the adhesion promoter layer is at least 1.8 N/15 mm, preferably at least 2.2 N/15 mm and particularly preferably at least 2.8 N/15 mm. In a special embodiment, the adhesion between the individual layers is so strong that the adhesion test causes the carrier layer to tear, in the case of cardboard as the carrier layer a so-called cardboard fiber tear.

### Connecting

Any connecting that appears suitable to the person skilled in the art for use according to the invention and by means of which a sufficiently strong connection can be obtained can be considered as the connecting. A preferred connecting is with a material bond. A connection with a material bond is understood here to be a connection between joining partners that is created by forces of attraction between materials or within a material. A particular distinction must be made between this and interlocking and frictionally engaged connections, which are created by geometric shapes or frictional forces. A preferred connection with a material bond can be one selected from the group consisting of sealing, welding, gluing, and pressing, or a combination of at least two thereof. The connecting with a material bond by means of a joining element is preferably a sealing, welding or gluing, wherein the joining element serves as a sealing agent, welding additive or adhesive. In the cases of sealing and welding, the connection is created by means of a liquid and its solidification. In the case of gluing, chemical bonds form between the interfaces or surfaces of the two objects to be joined, creating the connection. When sealing, welding or gluing, it is often advantageous to press the surfaces to be sealed or glued together. A preferred pressing of two layers is a pressing of a first surface of a first of the two layers onto a second surface of the second of the two layers facing the first surface over at least 20%, preferably at least 30%, more preferably at least 40%, more preferably at least 50%, more preferably at least 60%, more preferably at least 70%, even more preferably at least 80%, even more preferably at least 90%, most preferably at least 95%, of the first surface. A particularly preferred connecting is a sealing or a welding. A preferred sealing or welding includes as steps a contacting, heating and pressing, wherein the steps are preferably carried out in this sequence. Another sequence is also conceivable, in particular the sequence of heating, contacting and pressing. A preferred heating is heating a polymer layer, preferably a thermoplastic layer, more preferably a polyethylene layer or a polypropylene layer or both. A further preferred heating is heating a polyethylene layer to a temperature in a range from 80 to 140° C., more preferably from 90 to 130° C., most preferably from 100 to 120° C. A further preferred heating is heating a polypropylene layer to a temperature in a range from 120 to 200° C., more preferably from 130 to 180° C., most preferably from 140 to 170° C. A further preferred heating is performed to a sealing temperature of the polymer layer. Preferential heating can be achieved by friction, radiation, hot gas, heat contact to a solid, mechanical vibrations, preferably ultrasound, convection, or a combination of at least two of these measures. A particularly preferred heating method is through friction between the joining partners or through excitation of an ultrasonic vibration or through both. In the latter case, the friction can be generated in particular by exciting an ultrasonic vibration of one or both joining partners. A preferred welding is a friction welding. Therein, the joining partners are moved relative to one another under pressure, wherein the joining partners touch one another. The resulting friction causes heating. The relative movement can be generated, for example, by an ultrasonic vibration. This procedure is also referred to herein as friction welding in the case of connecting multi-layer composites (laminates).

### Foodstuff

All foodstuffs known to a person skilled in the art for human consumption and also animal feed can be considered as foodstuff. Preferred foodstuffs are liquid above 5° C., such as dairy products, soups, sauces and, preferably non-carbonated, drinks.

### Through-Hole

The at least one through-hole provided in a carrier layer according to preferred embodiments can have any form known to the person skilled in the art and suitable for various purposes and for emptying the container. Furthermore, the through-hole is preferably suitable for opening the container with a drinking straw or an opening aid. Possible opening aids are a pull tab and a screw cap. The through-hole is preferably covered with the corresponding layer in such a way that the through-hole is closed, preferably watertight. In the context of the invention, a through-hole for passing through a drinking straw is preferred. A preferred through-hole has a two-dimensional, rather than linear, opening area. Preferably, the through-hole is substantially circular, oval, elliptical or teardrop-shaped. The shape of the at least one through-hole in the carrier layer usually also predetermines the shape of the opening, which is created either by an openable closure connected to the container, through which the container contents are dispensed from the container after opening, or by a drinking straw in the container. Thus, the openings of the opened container often have shapes that are comparable or even identical to at least one through-hole in the carrier layer. Container designs with a single through-hole in a carrier layer primarily serve to release the foodstuff contained in the container. A further through-hole in a carrier layer can be provided in particular for ventilation of the container when the foodstuff is released. In conjunction with the covering of at least one through-hole in a carrier layer, the regions of the layers covering the same through-hole that cover the through-hole are also referred to as hole cover layers of the through-hole. These hole cover layers are preferably at least partially connected to one another, preferably to an extent of at least 30%, preferably at least 70% and particularly preferably at least 90%, of the area formed by the at least one through-hole. It is further preferred that the hole cover layers are connected to one another at the edges of the at least one through-hole and preferably lie connected to the edges in order to achieve improved tightness via a connection extending over the entire hole surface. Frequently, the hole cover layers are connected to one another via the area formed by the at least one through-hole in the carrier layer. This leads to a good tightness of the container formed from the composite and thus to a desired long shelf life of the foodstuffs stored in the container. Preferably, the at least one through-hole has a diameter in a range from 3 to 30 mm, more preferably from 3 to 25 mm, more preferably from 3 to 20 mm, more preferably from 3 to 15 mm, most preferably from 3 to 10 mm. The diameter of the through-hole here is the length of the longest straight line that starts and ends at the edge of the through-hole and runs through the geometric center of gravity of the through-hole.

### Opening/Opening Aid

In most cases, an opening in the container is created by at least partially destroying the hole cover layers covering at least one through-hole. This destruction can be done by cutting, pressing into the container or pulling out of the container. The destruction can be carried out by an opening aid connected to the container and arranged in the area of the at least one through-hole, usually above the at least one through-hole, for example by a drinking straw which is pushed through the hole covering layers. Furthermore, in an embodiment according to the invention, it is preferred that an opening aid is provided in the region of the at least one through-hole. In this case, it is preferred that the opening aid is provided on the surface representing the outside of the container. Furthermore, the container preferably includes a closure, for example a lid, on the outside of the container. It is preferred that the closure covers the through-hole at least partially, preferably completely. The closure thus protects the container wall, which is less robust than the areas outside the at least one through-hole, from harmful mechanical influences. To open the hole cover layers covering at least one through-hole, the closure often includes the opening aid. Suitable as such are, for example, hooks for tearing out at least part of the hole cover layers, edges or blades for cutting into the hole cover layers or thorns for pushing through the hole cover layers or a combination of at least two thereof. These opening aids are often mechanically coupled to a screw lid or a cap of the closure, for example via a hinge, so that the opening aid acts on the hole cover layers to open the closed container when the screw lid or cap is operated. Occasionally, in the technical literature, such closure systems, comprising composite layers covering a through-hole and openable closures with opening aids covering this hole, are referred to as “overcoated holes” with “applied fitments”.

### Measurement Methods

The following measurement methods were used within the scope of the invention. Unless otherwise stated, the measurements were performed at an ambient temperature of 23° C., an ambient air pressure of 100 kPa (0.986 atm), and a relative humidity of 50%.

### Separating Individual Layers

If individual layers of a laminate—such as the barrier layer—are to be examined, the layer to be examined is first separated from the laminate as described below. Three samples of the sheet-like composite are cut to size. For this purpose, unless otherwise stated, unfolded and ungrooved areas of the sheet-like composite are used. Unless otherwise stated, the sample pieces have dimensions of 4 cm×4 cm. If other dimensions of the layer to be examined are necessary for the examination to be carried out, sufficiently large sample pieces are cut from the laminate. The samples are placed in an acetic acid bath heated to 60° C. for 30 minutes (30% acetic acid solution: 30% by weight CH₃COOH, remainder to 100% by weight H₂O). This causes the layers to separate from one another. Here, the layers can also be carefully peeled away from one another manually if necessary. If the desired layer cannot be removed sufficiently well, new sample pieces are used as an alternative and treated in an ethanol bath (99% ethanol) as described above. If there are residues of the carrier layer (especially in the case of a cardboard layer as the carrier layer) on the layer to be examined (e.g. the polymer outer layer or the polymer intermediate layer), these are carefully removed with a brush. A sample of sufficient size for the examination to be carried out (unless otherwise stated, with an area of 4 cm²) is cut out from each of the three films prepared in this way. These samples are then stored at 23° C. for 4 hours and thus dried. The three samples can then be examined. Unless otherwise stated, the test result is the arithmetic mean of the results for the three samples.

### MFR Value

The MFR is measured according to ISO 1133-1:2012, Method A (mass determination method), unless otherwise stated at 190° C. and 2.16 kg.

### Density

The density is measured according to ISO standard 1183-1:2013.

### Scott Bond Value

The Scott Bond value is determined according to Tappi 569.

### Melting Temperature

The melting temperature is determined using the DSC method ISO 11357-1, -5. The device calibration is carried out according to the manufacturer's instructions using the following measurements:
Temperature Indium—Onset temperature,
Heat of fusion indium,
Temperature Zinc—Onset temperature.

The recorded measurement curve can have several local maxima (melting peaks), i.e. several melting temperatures. If a melting temperature above a certain value is required, this condition is met if one of the measured melting temperatures is above this value. When reference is made herein to a melting temperature of a polymer layer, a polymer composition or a polymer, in the case of several measured melting temperatures (melting peaks), the highest melting temperature is always meant, unless otherwise stated.

### Viscosity Number of PA

The viscosity number of PA is measured according to DIN EN ISO 307 (2013) in 95% sulfuric acid.

### Molecular Weight Distribution

The molecular weight distribution is measured according to gel permeation chromatography using light scattering: ISO 16014-3/-5 (2009-09).

### Moisture Content of the Cardboard

The moisture content of the cardboard is measured according to ISO 287:2009.

### Adhesion

To determine the adhesion of two adjacent layers, they are fixed on a 90° peel test device, for example from Instron “German rotating wheel fixture”, on a rotating roller that rotates at 40 mm/min during the measurement. The samples were previously cut into 15 mm wide strips. On one side of the sample, the layers are separated from one another and the detached end is clamped in a pulling device directed vertically upwards. A measuring device for determining the pulling force is attached to the pulling device. As the roller rotates, the force required to separate the layers from one another is measured. This force corresponds to the adhesion of the layers to one another and is given in N/15 mm. The detachment of the individual layers can be achieved mechanically, for example, or by targeted pretreatment, for example by soaking the sample for 3 minutes in 60° C., 30% acetic acid.

### Bending Stiffness

The following devices are used to determine the bending stiffness of a sheet-like material, in particular a sheet-like composite or cardboard:
Bending stiffness measuring device L&W Bending Tester Code 160, Type 977682 by Lorentzen & Wettre, Sweden,
Punch for bending stiffness samples.

The material to be tested is conditioned for 24 hours in standard climate (23° C., 50% relative humidity). The measurement is also carried out under standard climate. The punch is used to punch out samples with a width of 38.1 mm and a length of 69.85 mm from the material to be tested. For roll goods, samples are taken at 5 positions distributed across the web width. For each position, 2 samples are taken with their length in the running direction (machine direction—MD) and 2 samples with their length transverse to the running direction (cross direction—CD) to obtain a total of 10 samples in MD and 10 samples in CD. In any case, at least 4 samples should be taken, half of the samples with their length in MD and the other half with their length in CD. Samples may only be taken from ungrooved and unfolded areas of the material to be tested.

The bending stiffness (in mN) of the outer side and the opposite inner side is determined, both in MD and CD. To do this, the sample is placed in the test device with the side to be measured facing forward and the measurement is started by pressing the green button. For each of the combinations outside/MD, outside/CD, inside/MD and inside/CD, the same number of samples are measured. A 2-point bending test is carried out using the bending stiffness measuring device. The sample is clamped at one end and is bent at the other end by a measuring edge through a bending angle of 15°. Here, a direction in which the material has the bending stiffness is the direction of a straight line connecting the two points of application of the 2-point bending test. In the case of the bending stiffness measuring device, this direction is the direction of the shortest straight line from the clamp to the measuring edge. In this direction, the sample forms a curve when bent. A straight fold line would form perpendicular to this direction if the sample were bent far enough. The free clamping length of the sample is 50 mm. Each sample may only be used for one measurement. Measurements of the outside and the inside of the same sample are not permitted. The individual measured values are read from the display.

If for each of the combinations outside/MD, outside/CD, inside/MD and inside/CD several samples were measured, the arithmetic mean of the samples is calculated individually for each of the combinations. The arithmetic means are subsequently used as values for each of the 4 combinations. The bending stiffness in MD or CD is the geometric mean of the values for the combinations outside/MD and inside/MD or outside/CD and inside/CD, respectively. The direction-independent bending stiffness (hereafter “bending stiffness”) is the geometric mean of the values for all 4 combinations outside/MD, outside/CD, inside/MD and inside/CD.

### Angle

First, the sample is treated with ice spray. Next, a microtome is used to create a section through the sample with a cutting plane that runs parallel to the longitudinal axis of the container to be examined. With a Nikon E800 Eclipse microscope, an image of the location of the section to be examined is then taken. The angle to be determined is measured on this image using the Olympus Stream Essentials 2.4 software.

### Extensibility and Modulus of Elasticity

The extensibility indicates how far a material can be stretched before it breaks or tears. The following tools are used to determine the extensibility and the modulus of elasticity of a sheet-like material, such as a laminate or cardboard:
Lever safety cutting machine
Circle cutter (50 or 100 cm²)
Analytical balance
Thickness gauge
Universal tensile testing machine TIRA test 28025 (load cell: 1000 N)

The measurements are carried out according to the German version of the standard EN ISO 1924-2:2008 (identical to DIN EN ISO 1924-2:2009-05). In this, the extensibility is referred to as the strain at break and the modulus of elasticity is referred to as the modulus of elasticity. Sample preparation is described in the standard DIN EN 20187:1993. The following statements supplement the instructions in the standards and replace statements in the standards where they deviate from them.

The material to be tested is conditioned for 24 hours in standard climate (23° C., 50% relative humidity). The test is also carried out under standard conditions. Pre-drying within the meaning of paragraph 6.1 of DIN EN 20187:1993 is not carried out. Using the lever safety cutting machine, 5 strip-shaped samples of the sheet-like material to be examined are cut out. If the sheet-like material comprises a fibrous layer with an orientation direction of the fibers, 5 samples each with strip lengths in the orientation direction (machining direction MD) and strip lengths perpendicular to the orientation direction (transverse direction CD) are cut out. The strip width is 15 mm. The clamping length should be 180 mm, resulting in a strip length of at least 220 mm. The tensile strain occurs in the direction of the strip length. For roll goods, the samples are taken distributed across the roll width.

In addition, a sample is taken with the circle cutter and weighed on the analytical balance. The result is converted to the basis weight in g/m². The thickness gauge is used to measure the thickness of the circular sample. The contact pressure for determining the thickness (section 11 i) of the standard EN ISO 1924-2:2008) is 100 kPa.

Before measuring the strip-shaped samples, the method for tensile strain of the material type under investigation (for example, composite or cardboard) is opened on the tensile testing machine. The test speed is 20 mm/min. Under “Versuchseinstellungen” (Test Settings)—“Abmessungen” (Dimensions)—“Spezial” (Special), the thickness of the sample is entered. Then “prismatisch” (prismatic) is clicked on and also the thickness of the sample is entered. Then “Spezial” is clicked on again and the clamping length is checked. It is important to make sure that a return is made to “Spezial”, otherwise the basis weight will not be queried after the measurement has started.

Data about the sample is entered under “Versuchseinstellungen”—“Abmessungen”. Once all data has been entered, the measurement can begin. The force must not exceed 0.1 N. The test is then started via the traffic light symbol. A window opens for entering the basis weight of the samples. After entering the sample, sample number and basis weight, the measurement is started by “OK”. This procedure is then repeated for the remaining 4 samples or for the remaining 4 samples of the same material direction (MD or CD).

After completing the last measurement, the Excel transfer is carried out via the Excel symbol with the number 3 (select the variant DIN-ISO 1924-2 here) and this file is saved. Optionally, a PDF file can be created using “Seitenansicht” (Page View) and saved under the work card. The following values should be recorded: FH [N]/AH [%]/M [MPa]/I [Nm/g]. The test result is the arithmetic mean of the individual results of the 5 samples with the same material direction.

### Drop Simulation

For this purpose, the filled and closed container is inserted from above into a vertically suspended guide tube with a diameter adapted to the container size and then dropped. The tube has a length of about 1.5 m and is suspended 1 m above the ground. By guiding the container for the first 1.5 m of the fall in the tube, it is possible to let it fall reproducibly onto the container bottom or the container top in order to be able to investigate the effects on the container integrity.

### Liquid Tightness

Crystal Oil 60 from Shell Chemicals with methylene blue is used as a test agent for leak testing of the containers. Depending on the examination criterion, the container to be examined may be subjected to the corresponding drop simulation. The container is cut open along its circumference by a cut through the jacket element so that an open, cup-like container part, containing the closed container bottom, and an open, cup-like container part, containing the closed container head, are obtained. The first container part with the container bottom and the second container part with the container head are each first emptied and then filled with an amount of the test agent that is sufficient to completely cover the bottom of the respective cup-like container part. In particular, any sealing seam between the jacket element and an end element should be completely covered with the test agent. The container parts are then stored for 24 hours. After the storage period, each container part is visually examined on its outside to determine whether the test agent has caused blue discoloration in the event of a leak. If neither the first container part nor the second container part shows such discoloration, the container is considered liquid-tight.

If the tightness of container heads or container bottoms of different containers is to be compared, 500 identical containers of each container type to be compared are examined as described above. The result of the test is the number of 500 identical containers which show a leak after a storage period of 24 hours. These numbers are then compared for the different containers.

### Shelf Life

### Tools:

The following tools are required for the shelf life test.
Bacillus atrophaeus in alcoholic solution with concentration 10⁸ CFU/ml (colony forming units per ml, article number: SPE8102-8 from SIMICON GmbH, Munich, Germany)
Linden Grain Medium
Yeast extract-peptone-glucose medium (HPG, also Plate Count Agar, Oxoid CM 325)
Ethanol (purity: 99.9%)
Multipette M4 from Eppendorf (The pipette must be adjusted before inoculating with ethanol so that exactly 10 μl can be removed.)
Plastic Petri dishes with a diameter of 9 cm
Beakers
Sponge tweezers
Sterile cotton ball
Incubator room or incubator cabinet for an incubation temperature of 30° C.
Microscope
Sterile air workbench
Soldering iron

### Preparing the Spore Suspension:

Sufficient quantities of the above-mentioned commercially available Bacillus atrophaeus spore suspensions are diluted with ethanol to concentrations of 10⁶ CFU/ml and 10⁷ CFU/ml. This is done on the sterile air workbench. To obtain the spore suspension with 10⁷ CFU/ml, 9 ml of ethanol are added to each 1 ml of the undiluted suspension. To obtain the spore suspension with 10⁶ CFU/ml, another 9 ml of ethanol are added to each 1 ml of the spore suspension is diluted with 10⁷ CFU/ml. Dilution and mixing takes place in the beakers.

### Inoculating:

For each container type to be tested (containers with identically manufactured container bottom), 300 open containers are inoculated with 10 μl of the spore suspension with 10⁶ CFU/ml. A further 300 containers of each container type to be tested are each inoculated with 10 μl of the suspension with 10⁷ CFU/ml. Work is carried out on the sterile air workbench to prevent cross-contamination via the air.

Inoculating is carried out as spot inoculating on the sterile air workbench. For this purpose, the container production is interrupted once the container bottom is completed. The inoculation is therefore carried out on open and still unfilled containers with a sealed and flanged container bottom. For this purpose, the 10 μl of the respective spore suspension are added with a pipette into the interior of the open container at a single point on the sealing seam of the container bottom, i.e., on the connection between the jacket element and the end element of the container bottom. After applying the spore suspension to the single point on the sealing seam of the container bottom, the container is briefly swiveled so that the suspension can spread along the bottom seam. The inoculated, open containers are left on the sterile air workbench until the inoculated suspension has dried.

Per spore concentration (10⁶ CFU/ml and 10⁷ CFU/ml), 2 positive control containers and 2 negative control containers are also prepared. The negative control containers are not inoculated, but are processed like the test containers, i.e. they are also sterilized. The positive control containers are inoculated but not sterilized. For this purpose, the positive control containers are not placed in the filling machine for further processing after inoculating and drying, but are placed directly from the sterile air workbench into incubation for 14 days at 30° C.

### Completion of the Containers:

The inoculated and dried, open containers are filled with Linden Grain medium and then closed. The closed containers are incubated for 14 days at 30° C.

### Microbiological Evaluation:

The following work is again carried out on sterile air workbench. A cotton ball is soaked with the ethanol. The head area of the incubated and closed container is rubbed with the cotton ball and thus disinfected with the ethanol. The cotton ball is held with the sponge tweezers. The tip of the previously heated soldering iron is pressed into the disinfected container head in order to open the container without contamination so that the culture medium contained therein can be removed.

Furthermore, 0.5 to 1 ml of the culture medium is taken from each container and placed in a Petri dish. The sample in the Petri dish is poured over with 10 ml of HPG at 50° C. The sample and the HPG are mixed by gently moving the Petri dish in a figure-of-8 motion on a smooth surface. After mixing, it is awaited until the HPG has reached a gel-like consistency. Then the Petri dish is incubated at 30° C. for 48 hours. The Petri dishes are incubated upside down to prevent condensation from forming on the culture medium. Then the spore growth is determined.

The colonies of the test bacteria are usually brown to orange. The exact color can be determined from Petri dishes containing samples from the positive control containers. In case of doubt, a microscopic examination can be carried out to confirm the test bacterium.

If there is no colony of the test bacterium (Bacillus atrophaeus) in the Petri dish, the container from which the sample was taken is considered sterile with respect to the test bacteria. If a colony of the test bacterium has formed in the Petri dish, it is determined by counting whether the Petri dish contains 10 or fewer colony-forming units of the test bacterium. If this is the case, contamination via the air cannot be ruled out. Therefore, these samples are discarded. If there is a colony of the test bacterium with more than 10 colony-forming units in the Petri dish, the corresponding container is considered non-sterile.

For each container type examined, a ratio of the number of non-sterile containers to the total number of evaluated (i.e. not discarded) containers is obtained for each concentration of the spore suspension used for inoculation. These ratios are compared for the different container types at the same spore suspension concentration. The larger the ratio, the worse the shelf life of the respective container type is rated. In the overall evaluation, the results for the two spore suspension concentrations are treated equally.

The invention is illustrated in more detail below by examples and drawings, wherein the examples and drawings do not limit the invention. Furthermore, unless otherwise indicated, the drawings are not true to scale.

### Laminate Construction

In the examples (according to the invention) and comparative examples (not according to the invention), laminates with the layer structure given in Table 1 below were used to produce containers.

TABLE 1
Structure of the laminates of the examples and the comparative examples

| | | Basis weight |
|---|---|---|
| Layer name | Material | [g/m²] |
| Polymer outer layer | LDPE 23L430 from Ineos GmbH, | 15 |
| | Cologne, Germany | |
| Carrier layer | Cardboard: Stora Enso Natura T | 210 |
| | Duplex double-coated, Scott-Bond | |
| | 200 J/m², Residual moisture 7.5%, | |
| | bending stiffness 104 mN | |
| Polymer | LDPE 23L430 from Ineos GmbH, | 18 |
| intermediate | Cologne, Germany | |
| layer | | |
| Adhesion promoter | Escor 6000 HSC from Exxon | 3 |
| layer | Mobil Corporation | |
| Barrier layer | Aluminum, EN AW 8079 from | here: |
| | Hydro Aluminium Deutschland | thickness 6 μm |
| | GmbH | |
| Polymer inner layer | LDPE 23L430 from Ineos GmbH, | 15 |
| | Cologne, Germany | |

### Laminate Production

The laminates for the examples and comparative examples are produced using an extrusion coating system from Davis Standard. The extrusion temperature is in a range from approximately 280 to 330° C. In the first step, the polymer outer layer is coated over the entire surface of the carrier layer by layer extrusion. In the second step, the barrier layer together with the adhesion promoter layer and the polymer intermediate layer as laminating agents is applied over the entire surface of the carrier layer previously coated with the polymer outer layer. The polymer inner layer is then extruded over the entire surface of the barrier layer. To apply the individual layers by extrusion, the polymers are melted in an extruder. When a polymer is applied in a layer, the resulting melt is transferred via a feed block into a nozzle and extruded onto the carrier layer.

### Container Production

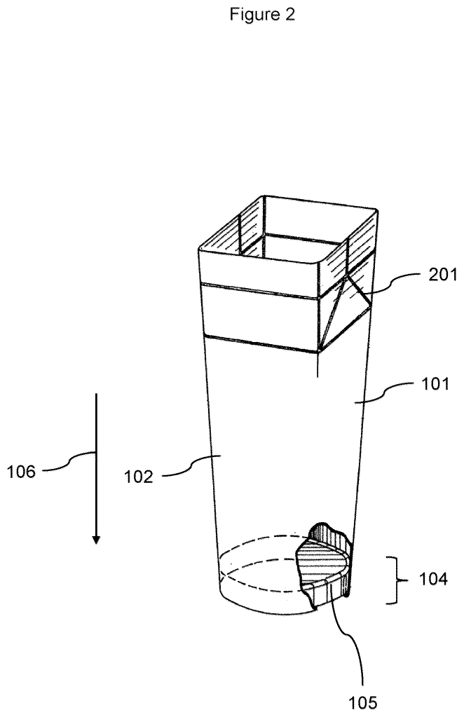

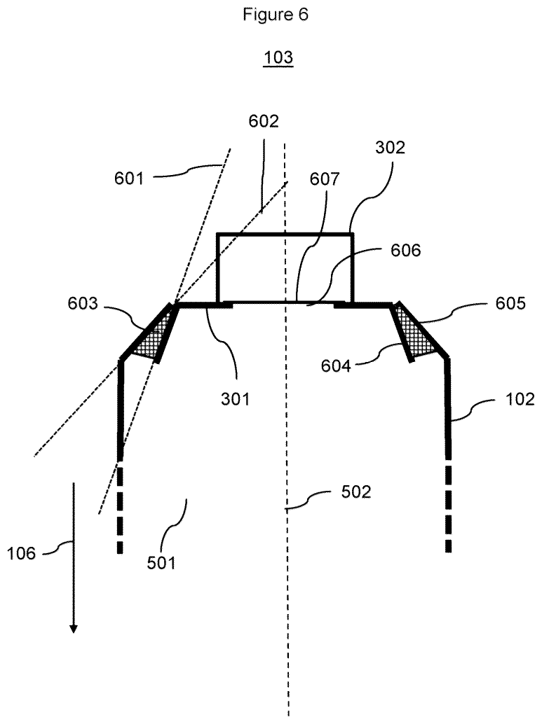

Elements of the container wall are separated by punching from the laminates obtained as described above. For each container, a rectangular jacket element and a circular end element are punched out. For each container with a 3-part container wall, a molded plastic part is also provided as an end element for the container head (see FIG. 6). When viewed from above, this has a centered pouring hole. Such an end element, which is circular in plan view, can be manufactured by injection molding. In the case of a container with a 2-part container wall, the jacket element of the container is provided with grooves on the outside (side of the polymer outer layer) before punching, which predefine fold lines for forming and closing the container head (see FIG. 2).

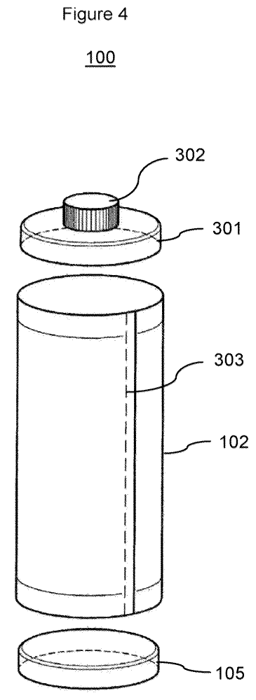

By overlapping contacting and sealing opposite longitudinal edges of each jacket element, the latter is formed into a hollow cylindrical structure of the type shown in FIG. 4. Sealing is done here as heat sealing by blowing hot air and using the polymer inner layer as a sealing agent.

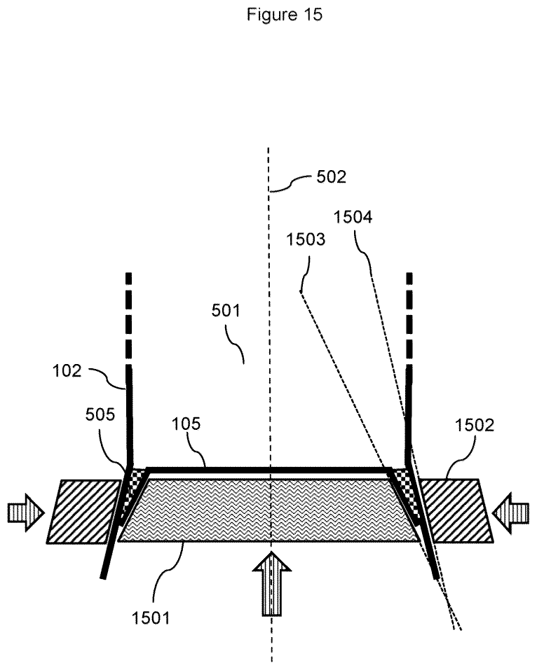

The hollow cylindrical structure thus obtained is placed into a precisely fitting cylindrical opening of a steel mold, with the lower edge of the structure flush with the edge of the opening. The end element for the bottom is now pressed into the opening with the polymer inner layer first by inserting a suitable tool into the opening and is thus concavely curved relative to the interior of the container. The end element thus formed has a central region and an edge enclosing the central region. Further, the end element is connected to the jacket element by ultrasonic friction welding as shown in FIG. 15. The exact geometry of the sealing seam thus obtained is determined by the design of the sonotrode and the anvil used for welding, in particular by the angles at which the surfaces of the tools that engage the container parts are positioned relative to one another during sealing. The seam shapes formed for the individual examples and comparative examples are summarized in Table 2. Furthermore, any excess of the jacket element is again flanged using ultrasound, i.e. folded over the edge of the end element and sealed to it. The length of the excess here is about 80% of the height of the edge of the end element.

In the case of a container with 2-part wall, it is now filled with 1 liter of water. The head area of the container is then closed by folding the jacket element along the grooves and connecting the folding surfaces using ultrasonic sealing.

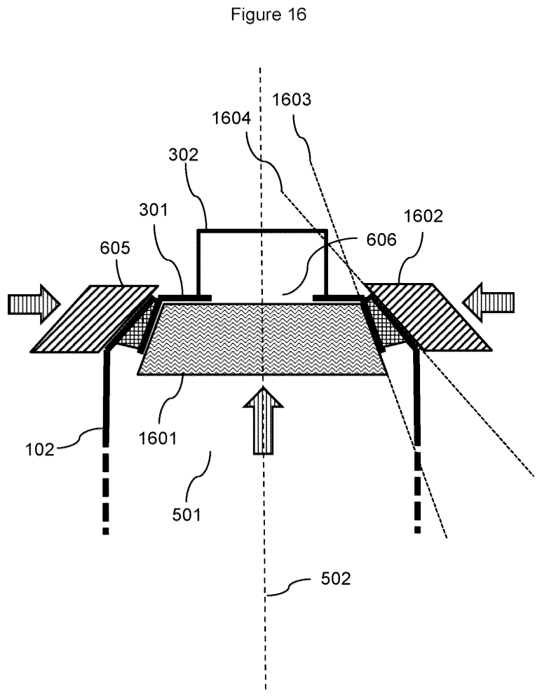

In the case of a container with a 3-part wall, the plastic molded part is inserted into the head area of the jacket element provided with the finished container bottom. The molded part is connected to the jacket element by ultrasonic friction welding as shown in FIG. 16. The exact geometry of the sealing seam thus obtained is determined by the design of the sonotrode and the anvil used for welding, in particular by the angles at which the surfaces of the tools that engage the container parts are positioned relative to one another during sealing. The seam shapes formed for the individual examples and comparative examples are summarized in Table 2. The container is filled with 1 liter of water through the pouring hole in the molded part. The pouring hole is then closed by sealing a strip of aluminum foil, which also forms the barrier layer and is coated on both sides with LDPE 23L430 from Ineos GmbH, Cologne, Germany, as a pull tab.

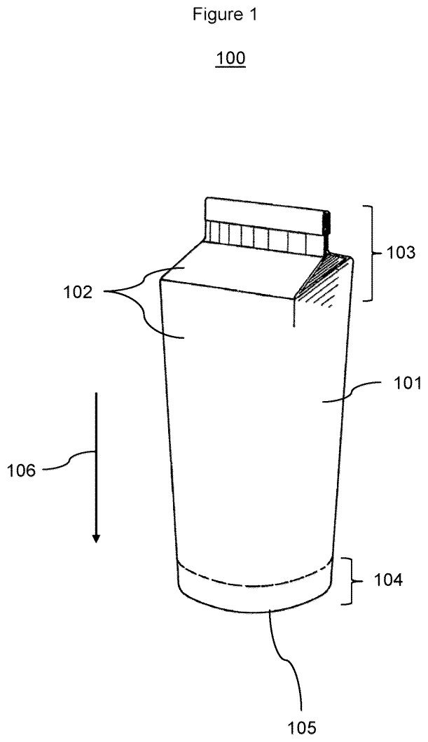

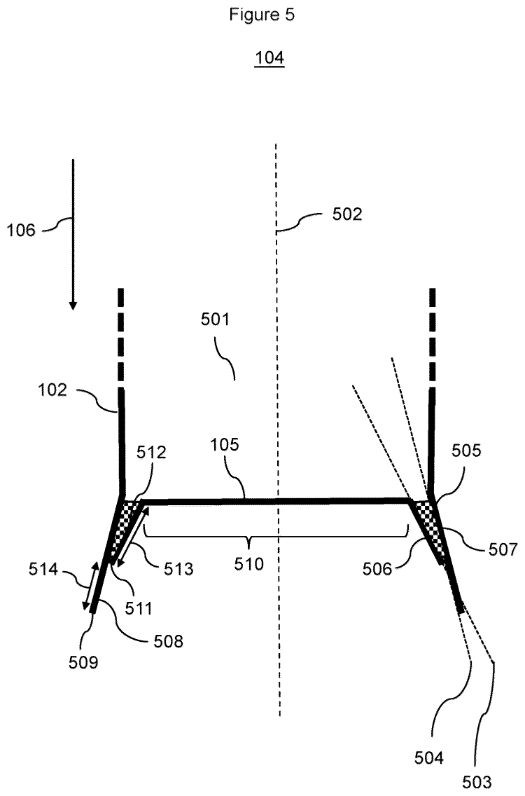

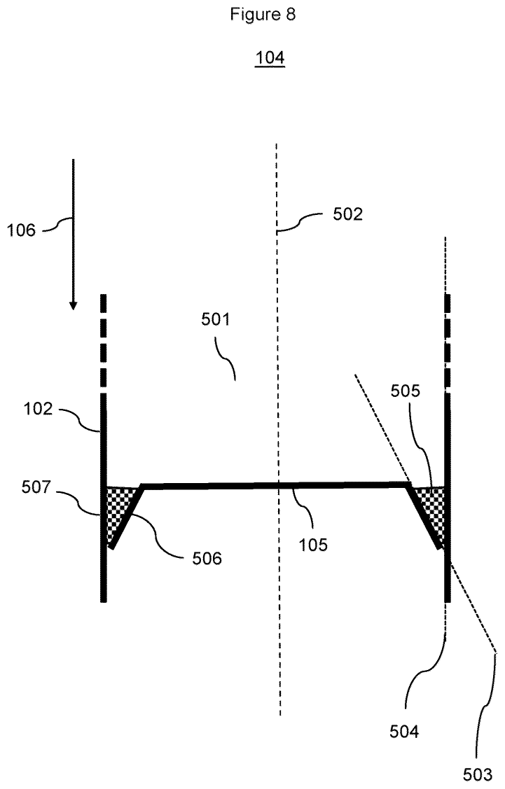

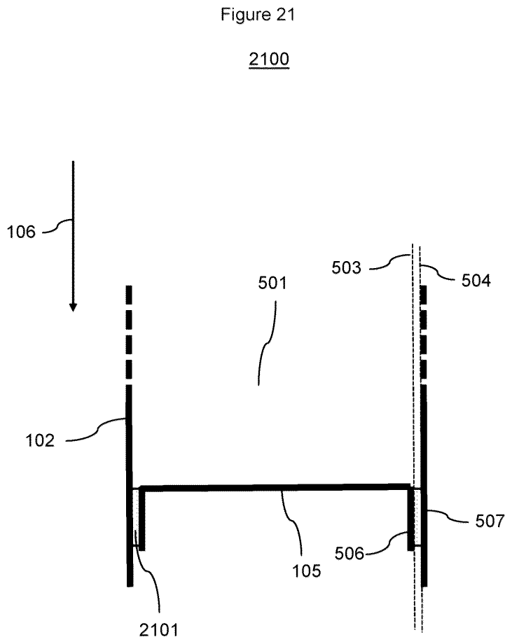

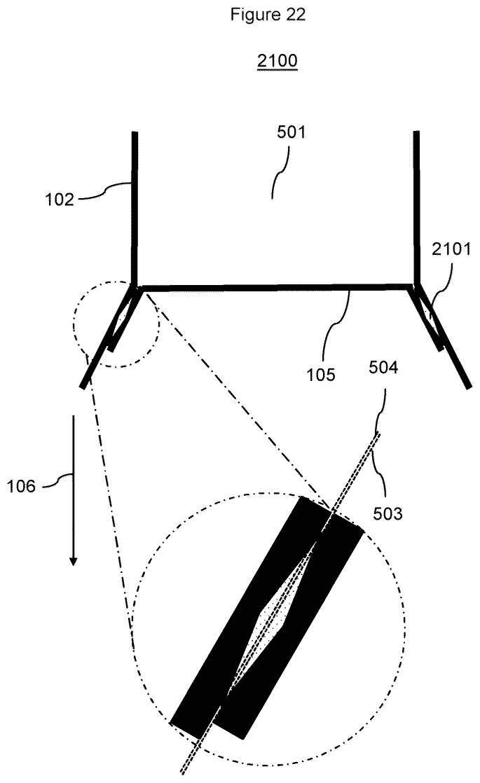

TABLE 2
Selected properties of the containers of the comparative examples and
examples

| | Number | | |
|---|---|---|---|
| | of parts | | |
| | of the | | |
| | container | Information on the | Information on the |
| | wall | bottom seam | head seam |
| Comparative | 2 | rectangular cross- | gable formed from |
| example 1 | | section, jacket edge not | jacket element (see |
| | | angled (see FIG. 21) | FIGS. 1 and 2) |
| Comparative | 3 | rectangular cross- | rectangular cross- |
| example 2 | | section, jacket edge not | section, jacket |
| | | angled (see FIG. 21) | edge not angled |
| | | | (see FIG. 21) |
| Comparative | 2 | bi-convex cross-section, | gable formed from |
| example 3 | | jacket edge angled | jacket element (see |
| | | outwards (see FIG. 22) | FIGS. 1 and 2) |
| Comparative | 3 | bi-convex cross-section, | bi-convex cross- |
| example 4 | | jacket edge angled | section, jacket edge |
| | | outwards (see FIG. 22) | angled inwards (see |
| | | | FIG. 22) |
| Example 1 | 2 | wedge-shaped, tip points | gable formed from |
| | | towards the container | jacket element (see |
| | | interior, jacket edge not | FIGS. 1 and 2) |
| | | angled, acute angle: 3.2° | |
| Example 2 | 2 | wedge-shaped, tip points | gable formed from |
| | | towards the container | jacket element (see |
| | | interior, jacket edge not | FIGS. 1 and 2) |
| | | angled, acute angle: 5.0° | |
| Example 3 | 2 | wedge-shaped, tip points | gable formed from |
| | | towards the container | jacket element (see |
| | | interior, jacket edge not | FIGS. 1 and 2) |
| | | angled, acute angle: 6.4° | |
| Example 4 | 2 | wedge-shaped, tip points | gable formed from |
| | | away from the container | jacket element (see |
| | | interior, jacket edge not | FIGS. 1 and 2) |
| | | angled, acute angle: 6.4° | |
| | | (see FIG. 8) | |
| Example 5 | 2 | wedge-shaped, tip points | gable formed from |
| | | towards the container | jacket element (see |
| | | interior, jacket edge | FIGS. 1 and 2) |
| | | angled outwards, acute | |
| | | angle: 6.4° (see FIG. | |
| | | 7) | |
| Example 6 | 2 | wedge-shaped, tip points | gable formed from |
| | | away from the container | jacket element (see |
| | | interior, jacket edge | FIGS. 1 and 2) |
| | | angled outwards, acute | |
| | | angle: 6.4° (see FIG. 5) | |
| Example 7 | 3 | wedge-shaped, tip points | wedge-shaped, tip |
| | | away from the container | points away from the |
| | | interior, jacket edge | container interior, |
| | | angled outwards, acute | jacket edge angled |
| | | angle: 6.4° (see FIG. | inwards, acute angle: |
| | | 5) | 5.5° (see FIG. 6) |

### Evaluation

500 containers of each example and each comparative example are subjected to the simulations of a drop onto the container bottom described above. A further 500 containers of each example and each comparative example are subjected to the simulation of a drop onto the container head described above. A further 500 containers of each example and each comparative example are not subjected to any drop simulation. The liquid tightness test described above is carried out on all these containers. The results of these tests are summarized in Table 3. For the respective criterion, +++ means a better result than ++, which means a better result than +, which in turn means a better result than 0, which in turn means a better result than −, which in turn means a better result than −−.

TABLE 3
Overview of advantages and disadvantages of the containers of the
comparative examples and examples

| | Liquid-tightness | | |
|---|---|---|---|
| | of container | Liquid- | Liquid-tightness |
| | bottom after | tightness | of container |
| | drop simulation | of container | head after drop |
| | onto container | head without | simulation onto |
| | bottom | drop simulation | container head |
| Comparative | −− | 0 | 0 |
| example 1 | | | |
| Comparative | −− | + | −− |
| example 2 | | | |
| Comparative | − | 0 | 0 |
| example 3 | | | |
| Comparative | − | + | − |
| example 4 | | | |
| Example 1 | 0 | 0 | 0 |
| Example 2 | + | 0 | 0 |
| Example 3 | + | 0 | 0 |
| Example 4 | ++ | 0 | 0 |
| Example 5 | ++ | 0 | 0 |
| Example 6 | +++ | 0 | 0 |
| Example 7 | +++ | + | + |

### Further Investigations

For further investigations, containers with two-part container wall are manufactured (see FIG. 1). For this purpose, type cb6 packaging sleeves commercially available from SIG Combibloc GmbH for cuboid containers with a packaging volume of 350 ml are used. The packing sleeves consist of a laminate with the layer structure shown in Table 1. These packing sleeves serve as jacket elements for the containers with two-part container wall. Thus, in contrast to FIGS. 1 and 2, no containers with a circular cross-section are manufactured. Instead, the containers in the further examples have a rectangular cross-section, with the rectangle having rounded corners.

As already described in the above examples, per each jacket element an end element for the container bottom is punched out of the laminate, which is constructed identically to the jacket elements. Here, the base element is rectangular and dimensioned in such a way that a container bottom can be formed from it by inserting it into the cb6 packing sleeve folded out into a cuboid shape, welding it to the packing sleeve and flanging it, in each case analogously to the above description of “container production”. For this purpose, the 4 corners of the end element are rounded with a radius of curvature of 15 mm. The tools (sonotrode and anvil) used to weld the end element to the jacket element are designed in each case in such a way that the acute angles of the wedge-shaped sealing seam connecting the jacket element to the end element, as specified in Table 4 below, are obtained.

Open containers with welded and flanged bottoms obtained in this way (see FIG. 2) are subjected to the “shelf life” test method described above. The inoculated and dried containers are fed directly from the sterile air workbench to a filling machine of type CFA 612 from SIG Combiloc GmbH. For this purpose, the respective container is inserted into the cell chain behind the mandrel wheel of the filling machine. The bottom guide of the cell chain must be adjusted so that the upper edge of the container is at the height required for processing. The container is then sterilized in the filling machine, filled at least halfway with the Linden Grain medium and, as is usual for cb6 containers, a container head is formed and closed by folding and welding the jacket element. For sterilization with H₂O₂ the following settings are used:
H₂O₂ concentration: 33%
H₂O₂ temperature: 250° C.
H₂O₂ spray flow: 350 μl/s
transport air flow: 150 l/min
preheating temperature: 165° C.
drying temperature: 155° C.

After incubation, the containers are microbiologically evaluated as described for the “shelf life” test method.

For each of the further examples A to L, a further 500 containers with welded and flanged bottoms obtained as described above are filled with water on the CFA 612 filling machine and closed. These containers are subjected to the simulation of a fall onto the container bottom described above. After the drop simulation, the containers are subjected to the liquid tightness test described above. The liquid tightness of the container bottom is investigated after the drop simulation.

The results of the tests on the containers of the further examples are summarized in Table 4. In Table 4, for the respective criterion, +++ means a better result than ++, which means a better result than +, which in turn means a better result than 0, which in turn means a better result than −. These relative figures refer only to the results given in Table 4.

TABLE 4
Overview of the acute angles of the wedge-shaped bottom seam and
advantages and disadvantages of the containers of the further examples

| | | Liquid-tightness of container | |
|---|---|---|---|
| | Acute | bottom after drop simulation | |
| | angle [°] | onto container bottom | Shelf life |
| Example A | 0.2 | − | − |
| Example B | 0.5 | 0 | 0 |
| Example C | 1.0 | + | 0 |
| Example D | 2.0 | ++ | + |
| Example E | 4.0 | ++ | ++ |
| Example F | 5.0 | +++ | +++ |
| Example G | 6.4 | +++ | +++ |
| Example H | 7.0 | ++ | ++ |
| Example I | 8.0 | ++ | + |
| Example J | 9.0 | + | 0 |
| Example K | 10.0 | 0 | 0 |
| Example L | 11.0 | − | − |

Unless otherwise indicated in the description or the respective drawing, the drawings show, schematically and not to scale:

FIG. 1 a schematic representation of a liquid-tight container according to the invention;

FIG. 2 a schematic representation of a precursor of the liquid-tight container of FIG. 1;

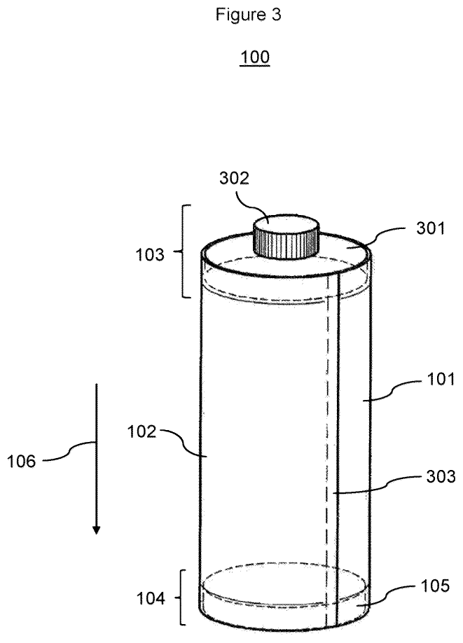

FIG. 3 a schematic representation of another liquid-tight container according to the invention;

FIG. 4 an exploded view of the liquid-tight container of FIG. 3;

FIG. 5 a schematic cross-sectional view of the container bottom of the liquid-tight containers of FIGS. 1 to 3;

FIG. 6 a schematic cross-sectional view of the container head of the liquid-tight container of FIG. 3;

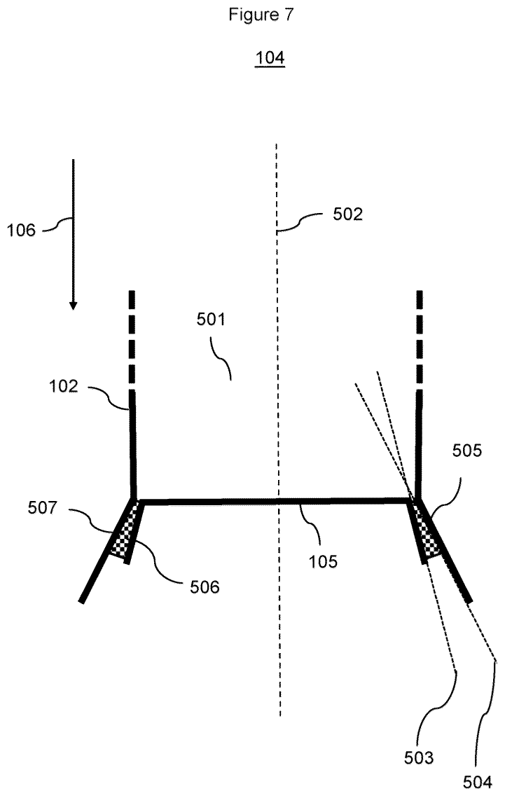

FIG. 7 a schematic cross-sectional view of a container bottom of another liquid-tight container according to the invention:

FIG. 8 a schematic cross-sectional view of a container bottom of another liquid-tight container according to the invention;

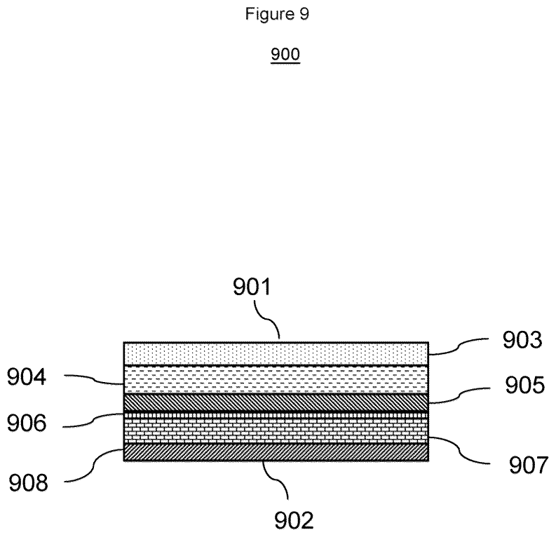

FIG. 9 a schematic cross-sectional representation of a sheet-like composite:

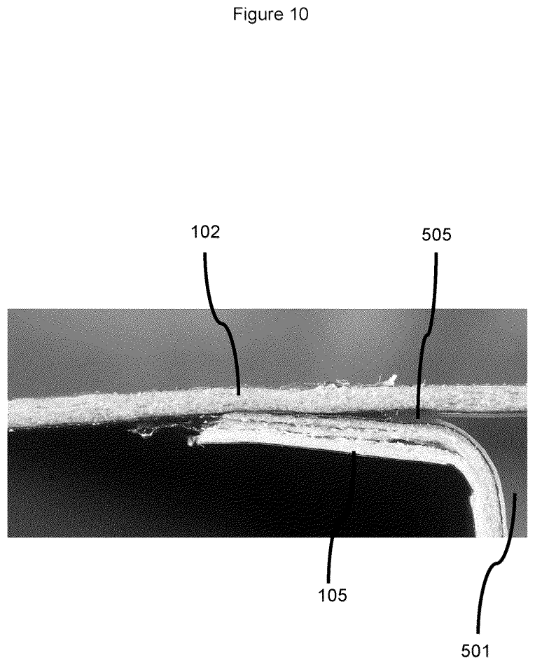

FIG. 10 a microscope image of a section through a seam in the container bottom of a liquid-tight container according to the invention:

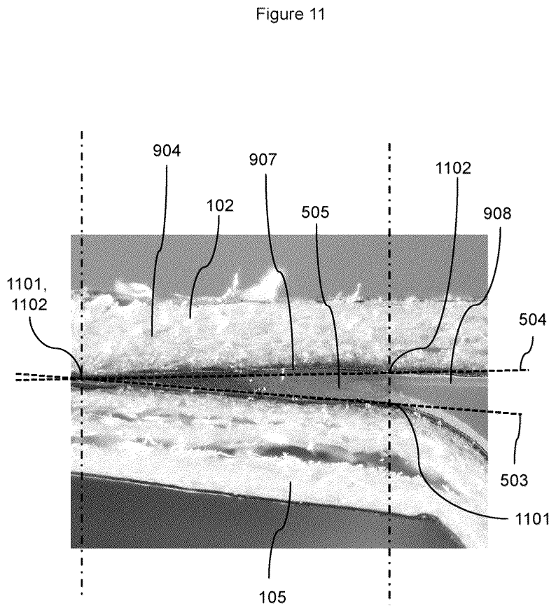

FIG. 11 an enlarged partial view of the microscope image of FIG. 11:

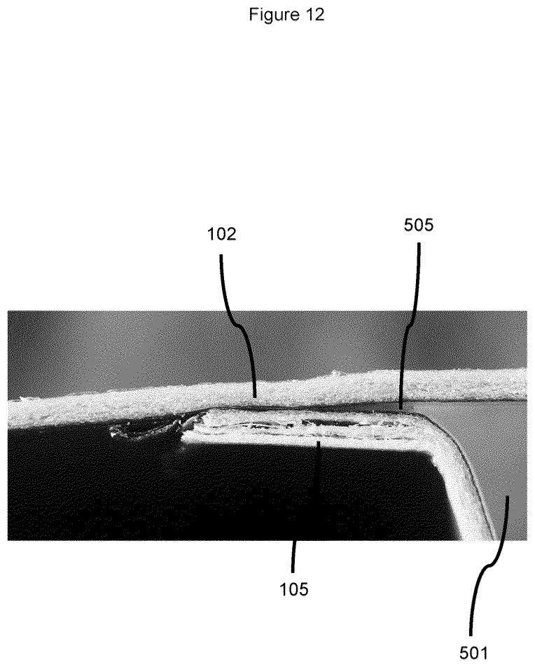

FIG. 12 a microscope image of a section through a seam in the container bottom of another liquid-tight container according to the invention;

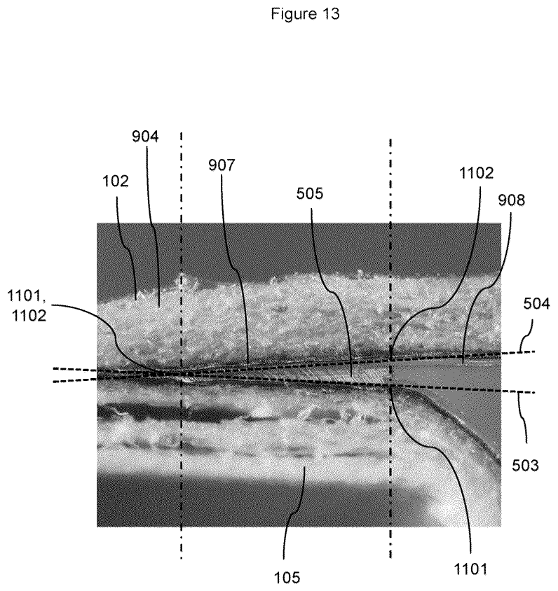

FIG. 13 an enlarged partial view of the microscope image of FIG. 12:

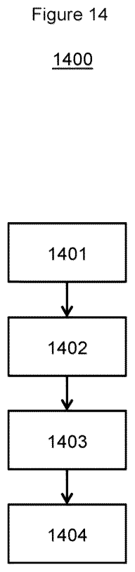

FIG. 14 a flow chart of a method according to the invention for producing a liquid-tight container:

FIG. 15 a schematic cross-sectional view to illustrate the method steps b) and c) of the method of FIG. 14:

FIG. 16 a schematic cross-sectional view to illustrate the method step d) of the method of FIG. 14;

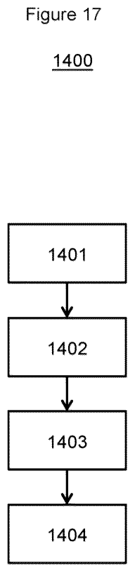

FIG. 17 a flow chart of another method according to the invention for producing a liquid-tight container:

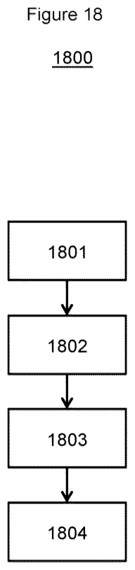

FIG. 18 a flowchart of a further method according to the invention:

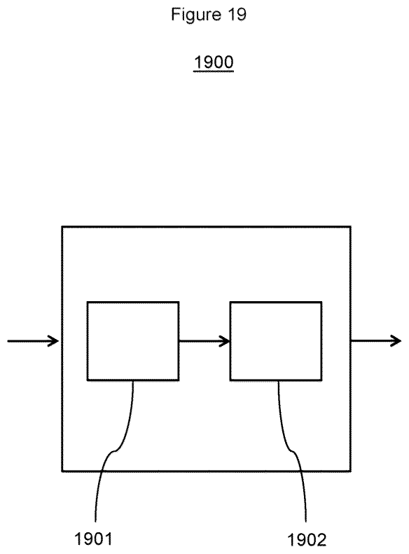

FIG. 19 a schematic representation of a device according to the invention for producing a liquid-tight container;

FIG. 20 a prior-art dimensionally stable foodstuff container:

FIG. 21 a schematic cross-sectional view of a container bottom of a container not according to the invention; and

FIG. 22 a schematic cross-sectional representation of a container bottom of another container not according to the invention.

FIG. 1 shows a schematic representation of a liquid-tight container 100 according to the invention, the container wall 101 of which is formed in two parts. One area of the container wall 101 surrounding a container interior is formed by a jacket element 102 and one area is formed by a first end element 105. Both the jacket element 102 and the first end element 105 consist of the sheet-like composite 900 shown in FIG. 9. The first end element 105 delimits the container interior in a first direction 106 along a length of the liquid-tight container 100. In addition, the first end element 105, relative to the length of the liquid-tight container 100, closes the liquid-tight container 100 at a first end which is formed by a container bottom 104. The jacket element 102 delimits the container interior, based on the length of the liquid-tight container 100, laterally and in a further direction opposite to the first direction 106. Furthermore, the jacket element 102 closes the liquid-tight container 100 at a further end, which is opposite the first end, relative to the length of the liquid-tight container 100, and which is formed by a container head 103. For this purpose, the jacket element 102 is folded at the further end and folding areas of the jacket element 102 are sealed together. Details of the container bottom 104 designed according to the invention can be seen in FIG. 5.

FIG. 2 shows a schematic representation of a precursor of the liquid-tight container 100 of FIG. 1. FIG. 2 shows the container 100 of FIG. 1 before the container 100 is closed at the further end with the jacket element 102. In order to facilitate folding of the jacket element 102 to close the further end, the jacket element has grooves 201 which specify the fold lines to be introduced. By folding along the grooves 201 and sealing the folding surfaces together, the liquid-tight container 100 of FIG. 1 can be obtained. FIG. 2 also shows the container bottom 104 cut at the first end. It can be seen that the jacket element 102 completely surrounds the first end element 105 laterally.

FIG. 3 shows a schematic representation of an inventive liquid-tight container 100, the container wall 101 of which is formed in 3 parts. One area of the container wall 101 surrounding a container interior is formed by a jacket element 102, one area is formed by a first end element 105, and one area is formed by a further end element 301. Both the jacket element 102 and the first end element 105 consist of the sheet-like composite 900 shown in FIG. 9. While the first end element 105 is formed from a circular piece of the sheet-like composite 900, the jacket element 102 consists of a rectangular cut of the sheet-like composite 900. Opposite longitudinal edges of this cut are contacted with one another in an overlapping manner and sealed together. The seam thus obtained is referred to as the longitudinal seam 303 of the liquid-tight container 100. The jacket element 102 laterally delimits the container interior, relative to a length of the liquid-tight container 100. The first end element 105 delimits the container interior in a first direction 106 along a length of the liquid-tight container 100. In addition, the first end element 105, relative to the length of the liquid-tight container 100, closes the liquid-tight container 100 at a first end which is formed by a container bottom 104. The further end element 301 is a molded part made of plastic with a circular shape in plan view and a central pouring hole 606. The further end element 301 delimits the container interior in a further direction opposite to the first direction 106. Furthermore, the liquid-tight container 100 has a closure lid 302. The pouring hole 606 of the further end element 301 is located under this closure lid 302. A pull tab 607, which consists of an aluminum foil coated on both sides with LDPE, is sealed over this pouring hole 606. The further end element 301 closes the liquid-tight container 100 together with the pull tab 607 at a further end, which is opposite the first end, relative to the length of the liquid-tight container 100, and which is formed by a container head 103. After the liquid-tight container has been opened by tearing off the pull tab 607, the closure lid 302 offers a possibility to reclose the liquid-tight container 100, although significantly less tightly. Details of the container bottom 104 designed according to the invention can be seen in FIG. 5. A section through the container head 103 is shown in FIG. 6.

FIG. 4 shows an exploded view of the container 100 of FIG. 3.

FIG. 5 shows a schematic cross-sectional view of the container bottom 104 of the liquid-tight containers 100 of FIGS. 1 to 3. These liquid-tight containers 100 further include a first joining element 505, by means of which the first end element 105 is connected with a material bond to the jacket element 102. The first joining element 505 was formed from the polymer inner layers 902 (see FIG. 9) of the first end element 105 and the jacket element 102 when the first end element 105 was connected to the jacket element 102. FIG. 5 shows a section through the container bottom 104, wherein the cutting plane is a first plane, which runs parallel to the length of the liquid-tight container 100 through the container interior 501. In this first plane, the jacket element 102, the first joining element 505 and the first end element 105 form layers of a first joining layer sequence. Over an entire lateral extent, relative to the first joining layer sequence, these layers follow one another directly. The first joining element 505 has a first surface contacting the first end element 105 and a second surface contacting the jacket element 102. An imaginary first straight line 503 connects both end points of a first line formed in the first plane by the first surface and lying within the first joining layer sequence. In addition, an imaginary second straight line 504 connects both end points of a second line formed in the first plane by the second surface and lying within the first joining layer sequence. The first straight line 503 forms a first acute angle with the second straight line 504. A vertex of this first acute angle is arranged in the first direction 106 arranged after the legs of the first acute angle. Furthermore, the first straight line 503 forms an angle in the range from 0.8 to 3.5° with the first direction 106. The second straight line 504 forms an angle in the range from 5.8 to 9.9° with the first direction 106. In addition, a region 506 of the first end element 105 that contacts the first surface is laterally angled outwards relative to the liquid-tight container 100. Also, a region 507 of the jacket element 102 which contacts the second surface is laterally angled outwards relative to the liquid-tight container 100. Furthermore, it can be seen that the first end element 105 is convex with respect to the container interior 501, i.e. curved away from the container interior 501. The container bottom 104 is rotationally symmetrical about an axis 502. Accordingly, there is, for 100% of an outer circumference of the jacket element 102, at least one first plane running parallel to the length of the liquid-tight container 100 through the container interior 501 and the outer circumference of the jacket element 102, in which the container bottom 104 is formed as shown in FIG. 5. Thus, the first joining element 505 is trapezoidal in every cross section. In space, the first joining element 505 has the shape of a ring-shaped wedge. It is thus wedge-shaped.

The jacket element 102 includes a first edge region 508 with a first edge 509 at a first end of the liquid-tight container 100. The first end element 105 consists of a central region 510 and a further edge region 512 which laterally encloses the central region 510 and has a further edge 511. The central region 510 delimits the container interior 501, relative to the length of the liquid-tight container 100, at the first end of the liquid-tight container 100 in the first direction 106 along the length of the liquid-tight container 100. The further edge region 512 is connected with a material bond to the jacket element 102 by means of the first joining element 505. The further edge 511 forms a closed curve with a circumference. The further edge region 512 has an edge width 513 extending from the further edge 511 to the central region 510 at each point of the closed curve. The first edge region 508 protrudes beyond the further edge region 512 at each point of the closed curve such that the first edge region 508 has an overhang width (514) from the further edge 511 to the first edge 509. This overhang width 514 is measured on a side of the first edge region 508 that faces away from the first end element 105. Along the entire circumference, the overhang width 514 is at least 30% of the edge width 513. In FIG. 5, the jacket element 102 is not (yet) flanged, i.e., the overhang width 514 is not folded over the further edge 511 and connected to the further edge region 512. Deviating from this, the liquid-tight container 100 according to the invention is preferably flanged.

FIG. 6 shows a schematic cross-sectional view of the container head 103 of the liquid-tight container 100 of FIG. 3. In the container head 103, the liquid-tight container 100 further comprises a further joining element 603, which connects the further end element 301 with a material bond to the jacket element 102. The further joining element 603 was formed from the polymer inner layer 902 (see FIG. 9) of the jacket element 102 when the further end element 301 was connected to the jacket element 102. FIG. 6 shows a section through the container head 103, wherein the cutting plane in the sense of the invention is a further plane, which runs parallel to the length of the liquid-tight container 100 through the container interior 501 and comprises a further joining layer sequence. This further joining layer sequence consists over its entire lateral extent, relative to the further joining layer sequence, of the jacket element 102, the further joining element 603 and the further end element 301 as directly successive layers. The further joining element 603 has a third surface contacting the further end element 301 and a fourth surface contacting the jacket element 102. An imaginary third straight line 601 connects both end points of a third line formed in the further plane by the third surface and lying within the further joining layer sequence. An imaginary fourth straight line 602 connects both end points of a fourth line formed in the further plane by the fourth surface and lying within the further joining layer sequence. The third straight line 601 forms a further acute angle with the fourth straight line 602. A vertex of this further acute angle is arranged in the further direction after the legs of the further acute angle. Furthermore, the third straight line 601 forms an angle in the range from 0.8 to 3.5° with the first direction 106. The fourth straight line 602 forms an angle in the range from 5.8 to 9.9° with the first direction 106. In addition, a region 604 of the further end element 301, which contacts the third surface, is laterally angled outwards relative to the liquid-tight container 100. In contrast, a region 605 of the jacket element 102 which contacts the fourth surface is laterally angled inwards relative to the liquid-tight container 100. Furthermore, it can be seen that the further end element 301 is concave with respect to the container interior 501, i.e. curved towards the container interior 501. The container head 103 is also rotationally symmetrical about the axis 502. Accordingly, there is, for 100% of an outer circumference of the jacket element 102, at least one further plane running parallel to the length of the liquid-tight container 100 through the container interior 501 and the outer circumference of the jacket element 102, in which the container head 103 is formed as shown in FIG. 6. Thus, the further joining element 603 is trapezoidal in every cross section. In space, the further joining element 603 has the shape of a ring-shaped wedge. It is thus wedge-shaped.

FIG. 7 shows a schematic cross-sectional view of a container bottom 104 of another liquid-tight container 100 according to the invention. The figure plane of FIG. 7 is a first plane in the sense of claim 1. The container bottom 104 shown differs from the container bottom 103 of FIG. 5 by a different arrangement of the first joining element 505. In particular, the vertex of the first acute angle in FIG. 7 in the first direction is arranged in front of the legs of the first acute angle.

FIG. 8 shows a schematic cross-sectional view of a container bottom 104 of another liquid-tight container 100 according to the invention. The figure plane of FIG. 8 is also a first plane within the meaning of claim 1. The container bottom 104 shown differs from the container bottom 103 of FIG. 5 by the angles that the first straight line 503 and the second straight line 504 form with the first direction 106. In addition, the region 507 of the jacket element 102 that contacts the second surface is non-angled relative to the liquid-tight container 100.

FIG. 9 shows a schematic cross-sectional view of a sheet-like composite 900. This consists of the following layers, which overlay one another over their entire surfaces from the outer surface 901 of the sheet-like composite 900 towards its inner surface 902: polymer outer layer 903, carrier layer 904, polymer intermediate layer 905, adhesive layer 906 and polymer inner layer 908. Suitable materials and basis weights of the layers are given in Table 1 above.

FIG. 10 shows a microscope image of a section through a seam in the container bottom 104 of a liquid-tight container 100 according to the invention. The figure plane of FIG. 10 is a first plane in the sense of claim 1. Accordingly, in the lower right corner of the figure, the container interior 501 can be seen. Furthermore, the first joining layer sequence consisting of jacket element 102, first joining element 505 and first end element 105 can be seen.

FIG. 11 shows an enlarged partial view of the microscope image of FIG. 10. Of the layers of the sheet-like composite 900 shown in FIG. 9, of which the jacket element 102 and also the first end element 105 consist, the carrier layer 904, the slightly shiny barrier layer 907 and the polymer inner layer 908 can be clearly seen in FIG. 11. Furthermore, it can be seen that the first joining element 505 is formed from the polymer inner layers 908 of the jacket element 102 and the first end element 105. The vertical dash-dot lines mark the lateral edges of the first joining layer sequence. In other words: the first joining layer sequence lies between the two vertical dash-dot lines. To the left of the left dash-dot line and to the right of the right dash-dot line, the first joining element 505 is missing, so that the immediate sequence of the layers is no longer given. The first surface of the first end element 105 forms a line in the figure plane shown. The intersection points of this line with the dash-dot lines are the end points 1101 of a first line formed in the plane of the figure by the first surface and lying within the first joining layer sequence. The first line is therefore precisely the portion of the line formed in the figure plane by the first surface, which lies within the first joining layer sequence, i.e., between the dash-dot lines. The first straight line 503 connects both end points 1101. Analogously, a second straight line 504 connects both end points 1102 of a second line formed in the figure plane by the second surface and lying within the first joining layer sequence. The first straight line 503 and the second straight line 504 form an acute angle of 5.7°.

FIG. 12 shows a microscope image of a section through a seam in the container bottom 104 of another liquid-tight container 100 according to the invention. The figure plane of FIG. 12 is a first plane in the sense of claim 1. Accordingly, in the lower right corner of the figure, the container interior 501 can be seen. Furthermore, the first joining layer sequence consisting of jacket element 102, first joining element 505 and first end element 105 can be seen.

FIG. 13 shows an enlarged partial view of the microscope image of FIG. 12. Otherwise, the description of FIG. 11 applies identically here, wherein the first straight line 503 and the second straight line 504 form an acute angle of 6.3°.

FIG. 14 is a flowchart of a method 1400 according to the invention for producing the liquid-tight container 100 of FIG. 3. In a method step a) 1401 the jacket element 102, the first end element 105, the further end element 301, a first joining tool 1501, a second joining tool 1502, a third joining tool 1601 and a fourth joining tool 1602 are provided. The first joining tool 1501 is a sonotrode for ultrasonic friction welding. The second joining tool 1502 is an anvil designed as a counter tool to the first joining tool 1501. In a subsequent method step b) 1402, the first end element 105 is contacted with a first tool surface of the first joining tool 1501 and the jacket element 102 is contacted with a second tool surface of the second joining tool 1502. In a method step c) 1403, the first end element 105 is connected with a material bond to the jacket element 102 by friction welding. This creates the first joining element 505 as shown in FIG. 5. Furthermore, the container 100 is thus closed at the first end. In a subsequent method step d) 1404, the container 100 is closed at the opposite end, based on the length of the container 100. For this purpose, the further end element 301 is contacted with a third tool surface of the third joining tool 1601 and the jacket element 102 is contacted with a fourth tool surface of the fourth joining tool 1602. The third joining tool 1601 is a sonotrode for ultrasonic friction welding. The fourth joining tool 1602 is an anvil designed as a counter tool to the third joining tool 1601. Further in the method step d) 1404, the further end element 301 is connected with a material bond to the jacket element 102 by friction welding. This creates the additional joining element 605 shown in FIG. 6. In addition, the liquid-tight container 100 of FIG. 3 is obtained.

FIG. 15 shows a schematic cross-sectional view to illustrate the method steps b) 1402 and c) 1403 of the method 1400 of FIG. 14. The figure is rotationally symmetrical about the axis 502. Consequently, the first joining tool 1501 shown is frustoconical. The second joining tool 1502 is ring-shaped. The arrows indicate directions of pressing forces during friction welding. Furthermore, it can be seen that a tangent 1503 placed on the first tool surface and a tangent 1504 placed on the second tool surface form a first acute tool angle.

FIG. 16 shows a schematic cross-sectional view to illustrate the method step d) 1404 of the method 1400 of FIG. 14. The figure is rotationally symmetrical about the axis 502. Consequently, the third joining tool 1601 shown is frustoconical. The fourth joining tool 1602 is ring-shaped. The arrows indicate directions of pressing forces during friction welding. Furthermore, it can be seen that a tangent 1603 placed on the third tool surface and a tangent 1604 placed on the fourth tool surface enclose another acute tool angle.

FIG. 17 is a flowchart of a further method 1400 according to the invention for producing the liquid-tight container 100 of FIG. 1. The method 1400 comprises method steps a) 1401 to d) 1404. The method steps a) 1401 to c) 1403 are identical to the steps of the same name described for FIG. 14. In method step c) 1403, the precursor from FIG. 2, which is closed at the first end and open at the further end, is first obtained. Here too, the container 100 is closed at the further end in method step d) 1404. For this purpose, the jacket element 102 is folded along the grooves 202 and folding areas are connected to one another by ultrasonic welding. This creates the liquid-tight container 100 of FIG. 1.

FIG. 18 is a flowchart of a further method 1800 according to the invention for producing the liquid-tight container 100 of FIG. 1. In this method 1800, the precursor from FIG. 2 is not created first. In a method step a. 1801 a jacket element 102, an end element 105, a first joining tool 1501 and a second joining tool 1502 are provided. In a subsequent method step b. 1802, the jacket element 102 at one of its ends, relative to a length of the jacket element 102, is closed while maintaining an open container. This is done analogously to method step d) 1404 of method 1400 of FIG. 17. In a method step c. 1803 the end element 105 is contacted with a first tool surface of the first joining tool 1501 and the jacket element 102 is contacted with a second tool surface of the second joining tool 1502. This is done analogously to method step b) 1402 of the method 1400 of FIG. 17. In a method step d. 1804, the end element 105 is connected with a material bond to the jacket element 102 by friction welding. This is done analogously to method step c) 1403 of the method 1400 of FIG. 17. The liquid-tight container 100 of FIG. 1 is obtained.

FIG. 19 shows a schematic representation of a device 1900 according to the invention for producing a liquid-tight container 100 in a method stream which is indicated by arrows in the figure. The device 1900 is a filling machine designed and set up to produce and fill the container 100 with a flowable foodstuff. To this end the device 1900 comprises a first closing apparatus 1901, a further closing apparatus 1902 and a filling apparatus (not shown). The first closing apparatus 1901 includes a first joining tool and a second joining tool. The further closing apparatus 1902 is arranged downstream of the first closing apparatus 1901 and includes a third joining tool and a fourth joining tool. The first closing apparatus 1901 is designed and set up to carry out the method steps b) 1402 and c) 1403, and the further closing apparatus 1902 is designed and set up to carry out the method step d) 1404, in each case of the method 1400 of FIG. 14. The filling apparatus can be arranged between the first 1901 and the further closing device 1902, or downstream of the further closing apparatus 1902.

FIG. 20 shows a dimensionally stable foodstuff container 2000 of the prior art with a one-piece container wall.

FIG. 21 shows a schematic cross-sectional view of a container bottom 2100 of a container not according to the invention. This container bottom 2100 differs from that shown in FIG. 5 in particular in that the joining element 2101 is rectangular in the section shown in FIG. 21. The first straight line 503 and the further straight line 504 are accordingly parallel and do not form any angle. The first 503 and the second straight line 504 are parallel to the first direction 106. Furthermore, neither the region 506 of the first end element nor the region 507 of the jacket element 102 is angled.

FIG. 22 shows a schematic cross-sectional view of a container bottom 2100 of another container not according to the invention. This container bottom 2100 differs from that shown in FIG. 5 in particular in that the joining element 2101 has the shape of a parallelogram in the section shown in FIG. 22. This can be clearly seen in the larger dash-dot circle, which shows an enlargement of the image section located in the smaller dash-dot circle. As a result, the first straight line 503 and the second straight line 504 are parallel to one another. They therefore do not form any angle. Furthermore, the first straight line 503 and the second straight line 504 form other angles with the first direction 106 than is the case in FIG. 5.

### LIST OF REFERENCE SIGNS

100 liquid-tight container according to the invention
101 container wall
102 jacket element
103 container head
104 container bottom
105 first end element/end element
106 first direction
201 grooves
301 further end element
302 closure lid
303 longitudinal seam
501 container interior
502 axis
503 first straight line
504 second straight line
505 first joining element
506 region of the first end element contacting the first surface
507 region of the jacket element contacting the second surface
508 first edge region
509 first edge
510 central region
511 further edge
512 further edge region
513 edge width
514 overhang width
601 third straight line
602 fourth straight line
603 further joining element
604 region of the further end element contacting the third surface
605 region of the jacket element contacting the fourth surface
606 pouring hole
607 pull tab
900 sheet-like composite
901 outer surface
902 inner surface
903 polymer outer layer
904 carrier layer
905 polymer intermediate layer
906 adhesive layer
907 barrier layer
908 polymer inner layer
1101 end points of a first line lying in the image plane and formed by the first surface
1102 end points of a second line lying in the image plane and formed by the second surface
1400 method according to the invention for producing a liquid-tight container
1401 method step a)
1402 method step b)
1403 method step c)
1404 method step d)
1501 first joining tool
1502 second joining tool
1503 tangent to first tool surface
1504 tangent to second tool surface
1601 third joining tool
1602 fourth joining tool
1603 tangent to third tool surface
1604 tangent to fourth tool surface
1800 method according to the invention for producing a liquid-tight container
1801 method step a.
1802 method step b.
1803 method step c.
1804 method step d.
1900 device according to the invention for producing a liquid-tight container
1901 first closing apparatus
1902 further closing apparatus
2000 prior-art dimensionally stable foodstuff container
2100 container bottom of a container not according to the invention
2101 joining element not according to the invention

1. A liquid-tight container, comprising a container wall at least partially enclosing a container interior, and a first joining element; wherein a jacket element and a first end element each form a region of the container wall;
wherein the jacket element
is at least partially formed from a first sheet-like material,
in relation to a length of the liquid-tight container laterally delimits the container interior, and
includes a first edge region with a first edge;
wherein the first sheet-like material
comprises a first cardboard, and
has a bending stiffness in the range of 50 to 600 mN;
wherein the first edge region is arranged at a first end of the liquid-tight container;
wherein the first end element includes a central region and a further edge region which surrounds the central region and has a further edge;
wherein the central region delimits the container interior, in relation to the length of the liquid-tight container, at the first end of the liquid-tight container in a first direction along the length of the liquid-tight container;
wherein the further edge region is connected with a material bond to the jacket element by means of the first joining element;
wherein the further edge forms a closed curve with a circumference;
wherein the further edge region has an edge width extending from the further edge to the central region at each point of the closed curve;
wherein the first edge region protrudes beyond the further edge region at each point of the closed curve such that the first edge region has an overhang width from the further edge to the first edge;
wherein the overhang width is measured on a side of the first edge region facing away from the first end element;
wherein the overhang width along at least 50% of the circumference is at least 30% of the edge width;
wherein at least one first plane running parallel to the length of the liquid-tight container through the container interior comprises a first joining layer sequence, over the entire lateral extent of which, relative to the first joining layer sequence, the jacket element, the first joining element and the first end element follow one another directly as layers;
wherein the first joining element has a first surface contacting the first end element and a second surface contacting the jacket element;
wherein an imaginary first straight line connects both end points of a first line formed in the at least one first plane by the first surface and lying within the first joining layer sequence;
wherein an imaginary second straight line connects both end points of a second line formed in the at least one first plane by the second surface and lying within the first joining layer sequence;
wherein the first straight line forms a first acute angle with the second straight line.

2. The liquid-tight container according to claim 1, wherein for at least 10% of an outer circumference of the jacket element there is at least one first plane running parallel to the length of the liquid-tight container through the container interior and the outer circumference of the jacket element, which comprises the first joining layer sequence, so that an imaginary first straight line connects both end points of a first line formed in the at least one first plane by the first surface and lying within the first joining layer sequence, and an imaginary second straight line connects both end points of a second line formed in the at least one first plane by the second surface and lying within the first joining layer sequence,
wherein the first straight line forms a first acute angle with the second straight line.

3. The liquid-tight container according to claim 1, wherein a vertex of the first acute angle is arranged in the first direction after the legs of the first acute angle.

4. The liquid-tight container according to claim 1, wherein the second straight line forms an angle in a range from 0.4 to 5.0° with the first direction.

5. The liquid-tight container according to claim 1, wherein the first sheet-like material has a first material direction and a further material direction,
wherein the first material direction at each point on a surface of the first sheet-like material is perpendicular to the further material direction and to a thickness of the first sheet-like material,
wherein the first sheet-like material meets one or more of the following criteria:
A] the first sheet-like material has an extensibility in the first material direction in the range from 2.5 to 10%;
B] the first sheet-like material has an extensibility in the further material direction in the range from 1 to 6%;
C] the first sheet-like material has a modulus of elasticity in the first material direction in the range from 800 to 4000 MPa;
D] the first sheet-like material has a modulus of elasticity in the further material direction in the range from 1500 to 6000 MPa.

6. The liquid-tight container according to claim 1, wherein the first acute angle is in a range from 0.5 to 10.0°.

7. The liquid-tight container according to claim 1, wherein the first joining element in the at least one first plane has the shape of a triangle or a quadrilateral.

8. The liquid-tight container according to claim 1, wherein the first end element, relative to the length of the liquid-tight container, is arranged at the first end of the liquid-tight container;
wherein the jacket element additionally delimits the container interior in a further direction opposite to the first direction.

9. The liquid-tight container according to any of the preceding claim 1, wherein the container interior contains a liquid.

10. A method for producing the liquid-tight container according to claim 1, the method comprising as method steps:
a) providing
i) a jacket element formed at least partially from a first sheet-like material,
ii) a first end element,
iii) a first joining tool, and
iv) a second joining tool,
wherein the first sheet-like material
comprises a first cardboard, and
has a bending stiffness in the range from 50 to 600 mN;
b) contacting
i) the first end element with at least a first tool surface of the first joining tool, and
ii) the jacket element with at least a second tool surface of the second joining tool; and
c) connecting the first end element to the jacket element with a material bond.

11. The method according to claim 10, wherein in method step b) the first tool surface and the second tool surface form a first acute tool angle.

12. The method according to claim 10, wherein the first joining tool oscillates in method step c) at a frequency in a range from 15 to 50 KHz.

13. The method according to claim 10, wherein the connecting with a material bond in method step c) is carried out by welding.

14. A method for producing the liquid-tight container according to claim 8, the method comprising as method steps
a. providing
i. a jacket element formed at least partially from a first sheet-like material,
ii. an end element,
iii. a first joining tool, and
iv. a second joining tool,
wherein the first sheet-like material
comprises a first cardboard, and
has a bending stiffness in the range from 50 to 600 mN;
b. closing the jacket element at one of its ends, relative to a length of the jacket element, thereby obtaining an open container;
c. contacting
i. the end element with at least a first tool surface of the first joining tool, and
ii. the jacket element with at least a second tool surface of the second joining tool; and
d. connecting the end element to the jacket element with a material bond.

15. A device for producing a liquid-tight container in a method stream, the device comprising as components
a] a first closing apparatus comprising a first joining tool and a second joining tool; and
b] a further closing apparatus arranged downstream of the first closing apparatus, comprising a third joining tool and a fourth joining tool;
wherein
A. the first closing apparatus is designed and set up to carry out the method steps b) and c), and the further closing apparatus is designed and set up to carry out the method step d), in each case of the method according to any of claim 10; or
B. the first closing apparatus is designed and set up to carry out method step b., and the further closing apparatus is designed and set up to carry out method steps c. and d., in each case of the method according to claim 14.

16. A use of the liquid-tight container according to claim 1 for storing or transporting a liquid.

17. A use of a sheet-like composite for producing the liquid-tight container according to claim 1;
wherein one selected from the group consisting of the jacket element, the first end element, and the further end element, or a combination of at least two thereof is formed at least partially, preferably completely, from the sheet-like composite.

18. A use of a first joining tool and a second joining tool for forming a container bottom or a container head of a liquid-tight container by means of
a} contacting
i} a first end element with at least a first tool surface of the first joining tool, and
ii} a jacket element with at least a second tool surface of the second joining tool, and
b} connecting the first end element to the jacket element with a material bond thereby obtaining the liquid-tight container according to claim 1.
